(19) United States
(12) Patent Application Publication
(10) Pub. No.: US 2023/0294071 A1
(43) Pub. Date: Sep. 21, 2023

(54) CARBON DIOXIDE CAPTURE USING COVALENT ORGANIC FRAMEWORKS

(71) Applicant: UNIVERSITY OF WYOMING, Laramie, WA (US)

(72) Inventors: Maohong FAN, Ames, IA (US); Xia CHEN, Laramie, WY (US)

(21) Appl. No.: 18/122,940

(22) Filed: Mar. 17, 2023

Related U.S. Application Data
(60) Provisional application No. 63/321,568, filed on Mar. 18, 2022.

(51) Int. Cl. B01J 20/26; B01D 53/86

(52) U.S. Cl. CPC B01J 20/262; B01D 53/8671; B01D 2255/70; B01D 2257/504; B01D 2258/06

(57) ABSTRACT

Embodiments described herein generally relate to compositions for CO₂ absorption, desorption, and/or capture and processes for making such compositions. Embodiments described herein also generally relate to processes for CO₂ absorption, CO₂ desorption, and/or CO₂ capture. In an embodiment, a composition for absorbing or desorbing CO₂ is provided. The composition includes an organic amine. the composition further includes a carbon organic framework, an ion thereof, or combinations thereof, the carbon organic framework comprising a plurality of carboxylic acids. In another embodiment, a process for capturing CO₂ from a gas stream is also provided. The process includes introducing the gas stream with a composition described herein under absorption conditions, the gas stream comprising CO₂. The process further includes forming a CO₂-enriched composition.

### BRIEF DESCRIPTION OF THE DRAWINGS

This application claims priority to U.S. Provisional Application No. 63/321,568, filed Mar. 18, 2022, which is incorporated herein by reference in its entirety.

### GOVERNMENT RIGHTS

The invention was made with government support under Grant No. 1632899 awarded by the National Science Foundation. The government has certain rights in the invention.

### BACKGROUND

### Field

Embodiments described herein generally relate to compositions for carbon dioxide (CO₂) absorption and CO₂ desorption, and to processes for making such compositions. Embodiments described herein also generally relate to processes for CO₂ absorption and for CO₂ desorption.

### Description of the Related Art

Carbon dioxide (CO₂) is a primary greenhouse gas that makes a great contribution to global warming, owing to the excessive emissions from the combustion of fossil fuels. Carbon capture, utilization, and storage (CCUS) is the mature technology that can be carried out to alleviate the CO₂ discharge, which is urgently needed for achieving the goals set in the Paris Climate Accord. Amine-based CO₂ absorption is a potentially cost-effective options for capturing CO₂ from both gas streams (for example, flue gas) and the atmosphere. CO₂ capture is critical because of its increasing importance as a resource for material and fuel synthesis.

A fundamental challenge of chemisorption-based technologies is the slow absorption and desorption reaction kinetics when CO₂ desorption is at temperatures greater than 100° C. Here, excessive energies may be needed to vaporize a large amount of liquid water during the CO₂ desorption operation and condense the same amount of water vapor prior to CO₂ desorption during cyclic CO₂ sorption and desorption. Monoethanolamine (MEA) solution has low price and high reactivity with CO₂, which apply to the benchmark solvent for evaluating amine-based CO₂ capture processes at small scale. However, this technology is still not acceptable for versatile and large-scale uses mainly, attributed to (1) the critical limitations for >100° C. CO₂ desorption or very energy intensive MEA regeneration process, and (2) the resultant aggregated MEA degradation, as well as (3) severe corrosion at such high temperatures. In other words, to render fast CO₂ desorption from aqueous solvent, high temperature (120-140° C.) conditions are utilized with state-of-the-art methods, resulting in excessive energy demands for the water vaporization.

There is a need for new and improved compositions for the absorption, desorption, and/or capture of CO₂ that overcomes one or more deficiencies in the art. There is also a need for new and improved processes for the absorption, desorption, and/or capture of CO₂ that overcomes one or more deficiencies in the art.

### SUMMARY

Embodiments described herein generally relate to compositions for CO₂ absorption, desorption, and/or capture and processes for making such compositions. Embodiments described herein also generally relate to processes for CO₂ absorption, CO₂ desorption, and/or CO₂ capture.

In an embodiment, a composition for absorbing or desorbing carbon dioxide is provided. The composition includes an organic amine. The composition further includes a carbon organic framework, an ion thereof, or combinations thereof, the carbon organic framework comprising a plurality of carboxylic acids.

Implementations may include one or more of the following. The organic amine of the composition can exist in an ionic state or non-ionic state in the composition. The composition can further include water. The composition can include greater than 0 wt % and about 1 wt % (about 10,000 ppm) or less of the carbon organic framework based on a total wt % of the composition, the total wt % of the composition not to exceed 100 wt %. The composition can include greater than 0 wt % about 0.05 wt % (about 500 ppm) or less of the carbon organic framework based on a total wt % of the composition, the total wt % of the composition not to exceed 100 wt %. The composition can include about 0.005 wt % (about 50 ppm) to about 0.015 wt % (about 150 ppm) of the carbon organic framework based on a total wt % of the composition, the total wt % of the composition not to exceed 100 wt %. The organic amine of the composition can include a primary organic amine compound, a secondary organic amine compound, a tertiary organic amine compound, or combinations thereof. The organic amine of the composition can include monoethanolamine, diethanolamine, triethanolamine, diisopropanolamine, monomethyl-ethanolamine, methyldiethanolamine, diethyl-monoethanolamine, or combinations thereof. The organic amine of the composition can include a polyethylene amine, the polyethylene amine comprising diethylenetriamine, triethylenetetramine, tetraethylenepentamine, tetraacetylethylenediamine, pentaethylenehexamine, polyethyleneimine, or combinations thereof.

In another embodiment, a process for capturing carbon dioxide (CO₂) from a gas stream is provided. The process includes introducing the gas stream with a composition described herein under absorption conditions, the gas stream comprising CO₂. The process further includes forming a CO₂-enriched composition.

Implementations may include one or more of the following. The organic amine of the composition utilized in the process can be selected from the group consisting of monoethanolamine, diethanolamine, triethanolamine, diisopropanolamine, monomethyl-ethanolamine, methyldiethanolamine, diethyl-monoethanolamine, diethylenetriamine, triethylenetetramine, tetraethylenepentamine, tetraacetylethylenediamine, pentaethylenehexamine, polyethyleneimine, or combinations thereof. The composition utilized in the process can include greater than 0 wt % and about 1 wt % (about 10,000 ppm) or less of the carbon organic framework based on a total wt % of the composition, the total wt % of the composition not to exceed 100 wt %. The composition used in the process can include about 10 wt % to about 30 wt % of the organic amine based on a total wt % of the composition, the total wt % of the composition not to exceed 100 wt %. The composition used in the process can further include water, an ion thereof, or combinations thereof. At least a portion of the composition used in the process can be ultrasonically pretreated.

In another embodiment, a process for capturing CO₂ from a gas stream is provided. The process includes contacting the gas stream, under absorption conditions, with a composition described herein in an absorption unit to form a CO₂-enriched composition, the gas stream comprising CO₂. The process further includes passing the CO₂-enriched composition to a desorption unit, heating at least a portion of the CO₂-enriched composition in the desorption unit, and separating CO₂ from the CO₂-enriched composition to form a CO₂-depleted composition. The process further includes regenerating the composition from at least a portion of the CO₂-depleted composition, recycling at least a portion of the CO₂-depleted composition to the absorption unit, or both. Implementations may include heating the at least a portion of the CO₂-enriched composition at a temperature of about 100° C. or less.

In another embodiment, a process for making a composition for absorbing or desorbing carbon dioxide (CO₂) is provided. The process includes ultrasonically treating a mixture of a carbon organic framework and water. The process further includes adding an organic amine to the ultrasonically-treated mixture of the carbon organic framework and the water to form the composition.

In another embodiment, a process for desorption of carbon dioxide (CO₂) from a CO₂-enriched composition is provided. The process includes heating a CO₂-enriched composition under desorption conditions, the CO₂-enriched composition derived from a composition comprising an organic amine, an ion thereof, or a combination thereof, and a carbon organic framework, an ion thereof, or combinations thereof, the carbon organic framework comprising a plurality of carboxylic acids. The process further includes separating CO₂ from the CO₂-enriched composition to form a CO₂-depleted composition. Implementations may include one or more of the following. The composition can further include water.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

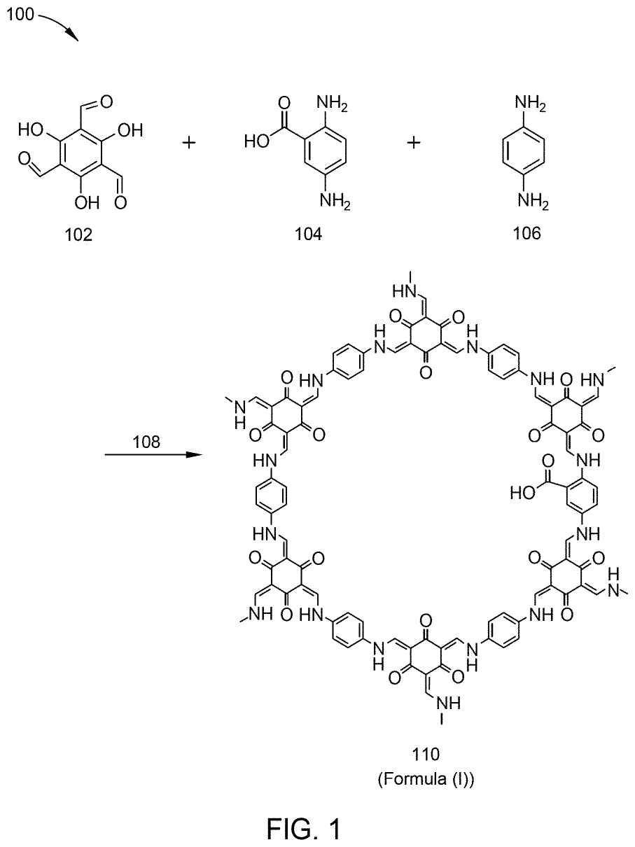

FIG. 1 is a reaction diagram for forming an example carbon organic framework (COF) catalyst according to at least one embodiment of the present disclosure.

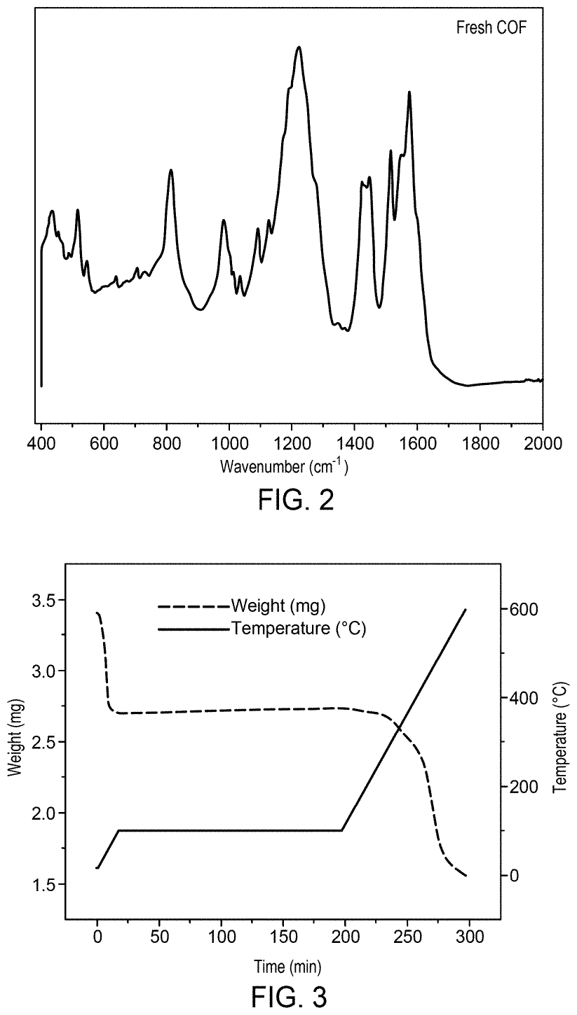

FIG. 2 shows exemplary Fourier transform infrared spectroscopy (FT-IR) data of an example COF catalyst according to at least one embodiment of the present disclosure.

FIG. 3 shows exemplary thermal gravimetric analysis (TGA) data according to at least one embodiment of the present disclosure.

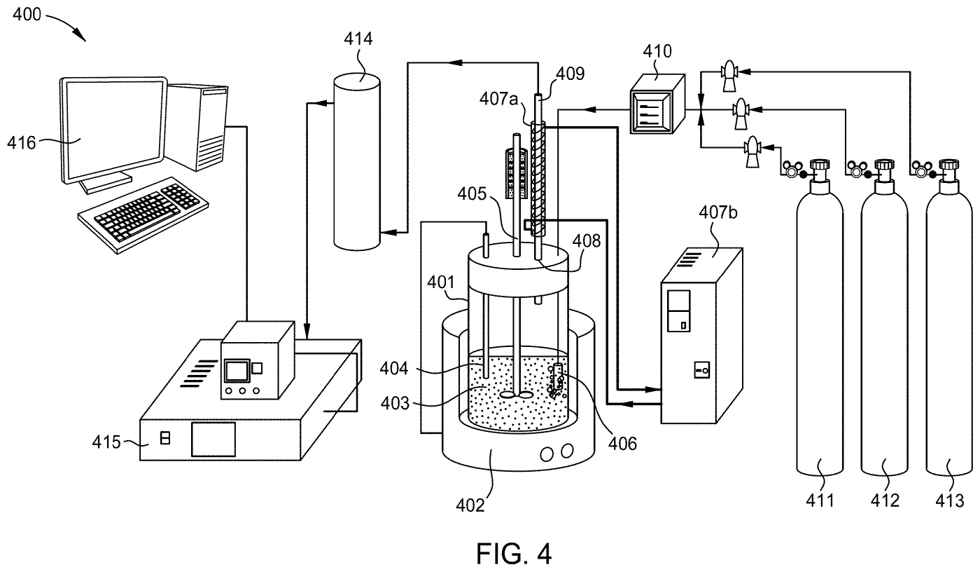

FIG. 4 is a schematic diagram of an example apparatus for CO₂ absorption and desorption according to at least one embodiment of the present disclosure.

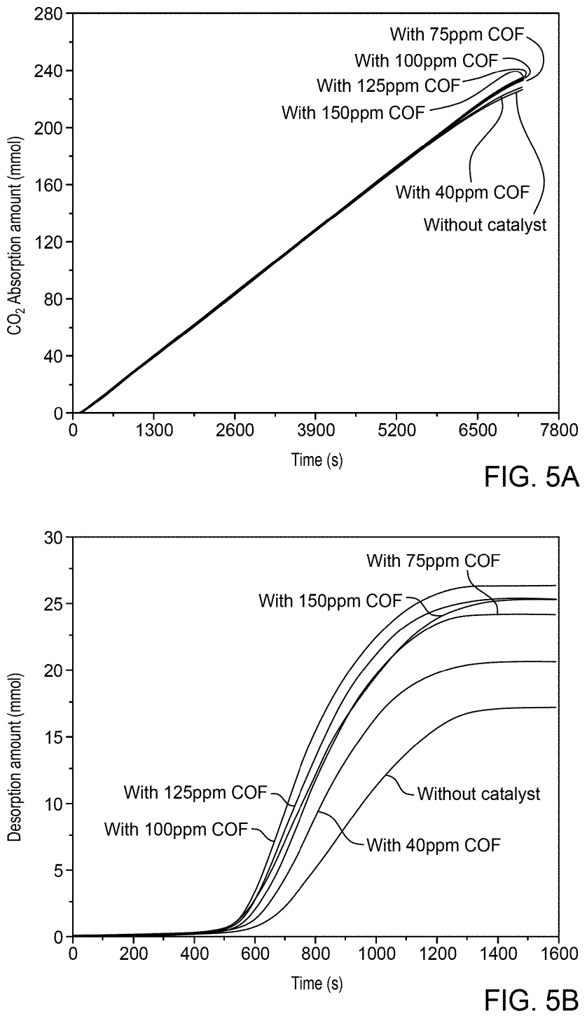

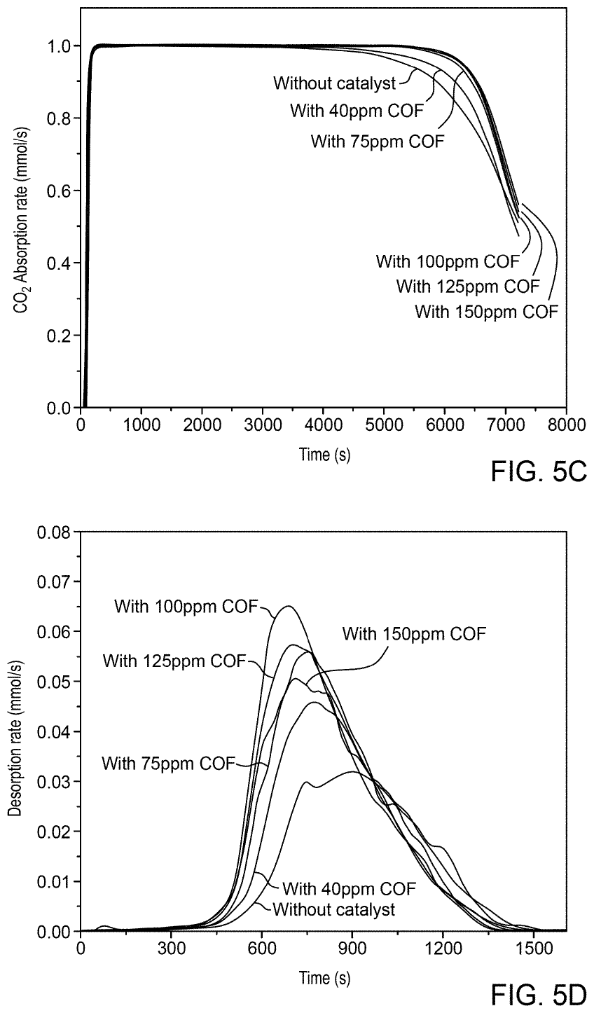

FIG. 5A shows exemplary data for the catalytic effects of the dosage of an example COF catalyst on the amount of CO₂ absorbed according to at least one embodiment of the present disclosure.

FIG. 5B shows exemplary data for the catalytic effects of the dosage of an example COF catalyst on the amount of CO₂ desorbed according to at least one embodiment of the present disclosure.

FIG. 5C shows exemplary data for the catalytic effects of the dosage of an example COF catalyst on the rate of CO₂ absorption according to at least one embodiment of the present disclosure.

FIG. 5D shows exemplary data for the catalytic effects of the dosage of an example COF catalyst on the rate of CO₂ desorption according to at least one embodiment of the present disclosure.

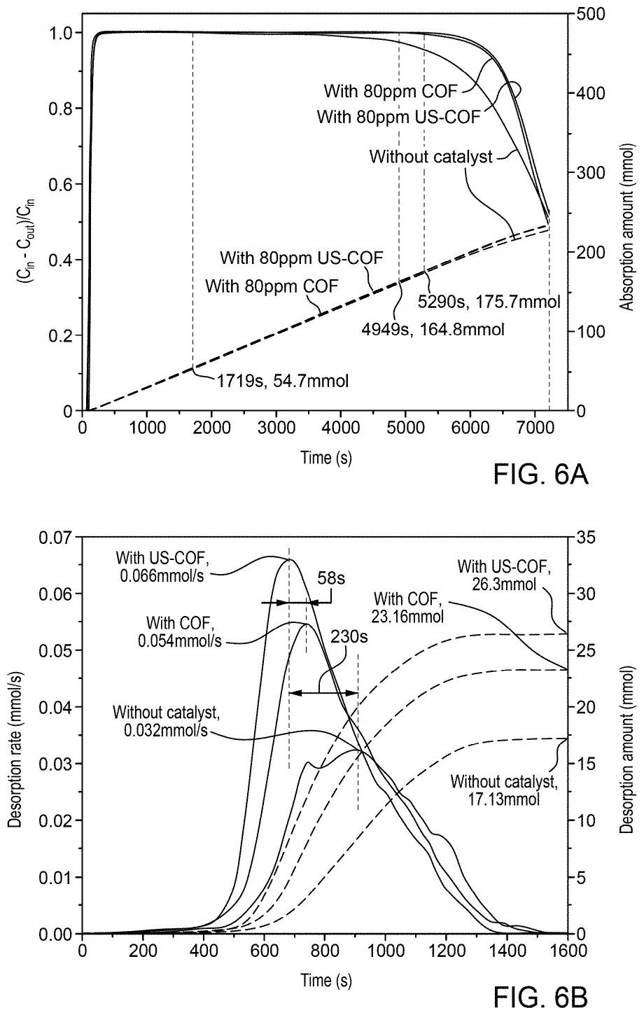

FIG. 6A shows exemplary data for CO₂ absorption using example compositions, with and without an ultrasonic pretreatment, according to at least one embodiment of the present disclosure.

FIG. 6B shows exemplary data for CO₂ desorption using example compositions, with and without an ultrasonic pretreatment, according to at least one embodiment of the present disclosure.

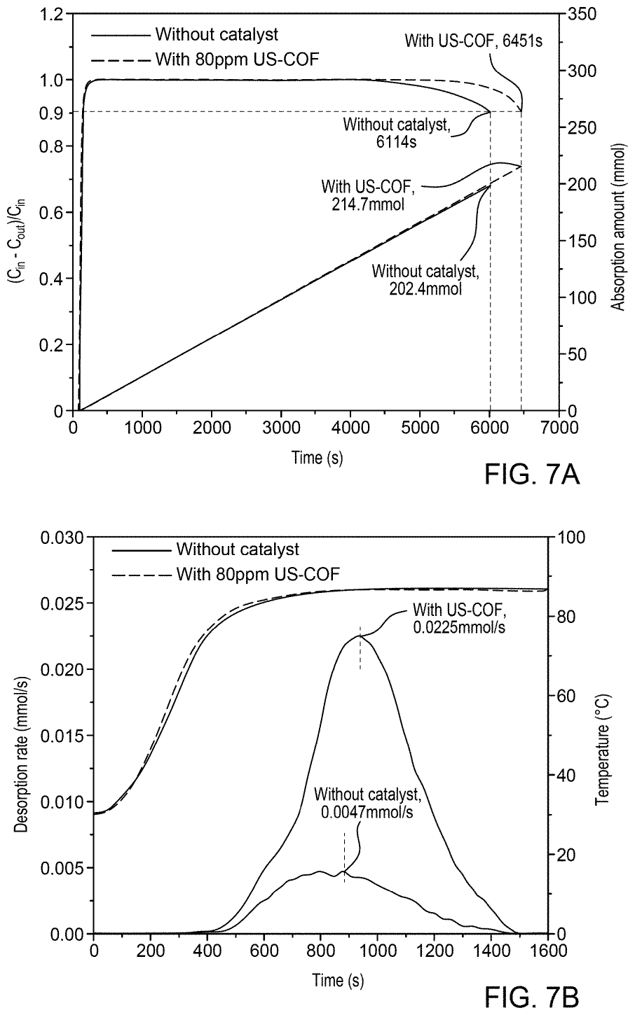

FIG. 7A shows exemplary data for CO₂ absorption using an example ultrasonically pretreated composition when the absorption process was terminated at 90% CO₂ capture efficiency according to at least one embodiment of the present disclosure.

FIG. 7B shows exemplary data for CO₂ desorption using an example ultrasonically pretreated composition according to at least one embodiment of the present disclosure.

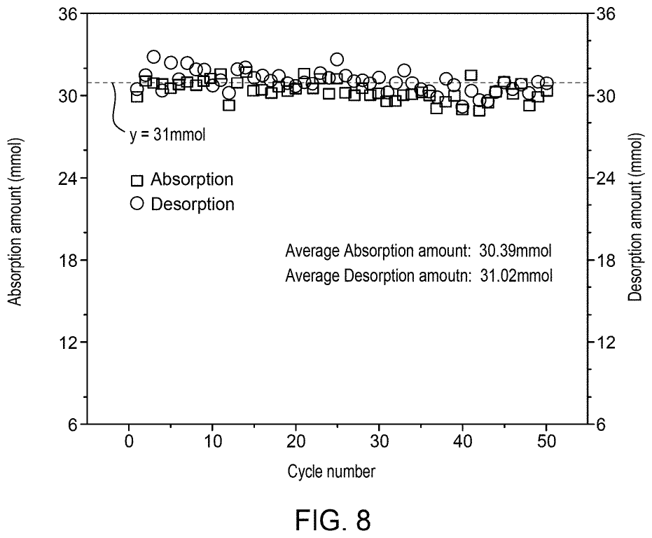

FIG. 8 shows exemplary data for the stability of an example ultrasonically pretreated composition over 50 absorption-desorption cycles according to at least one embodiment of the present disclosure.

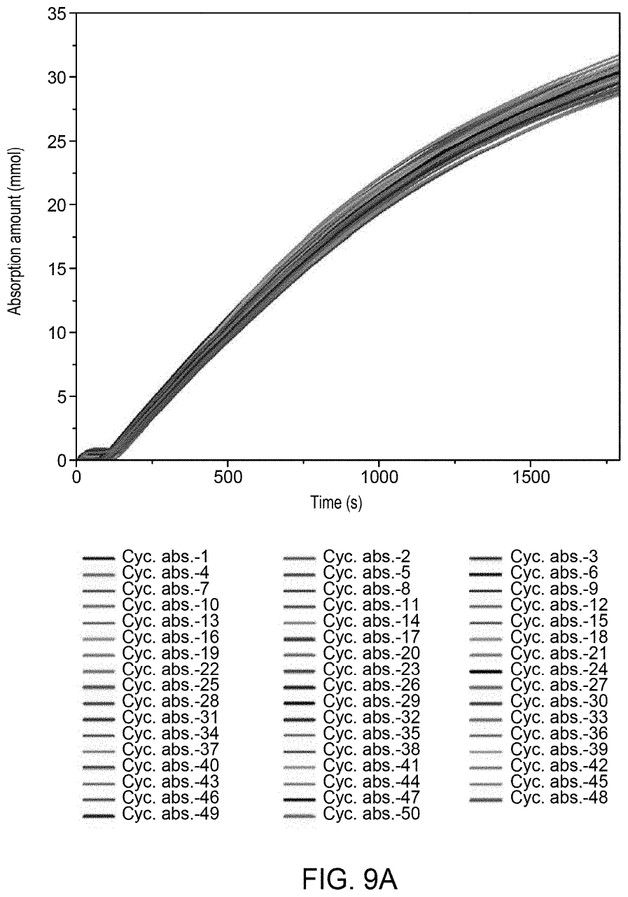

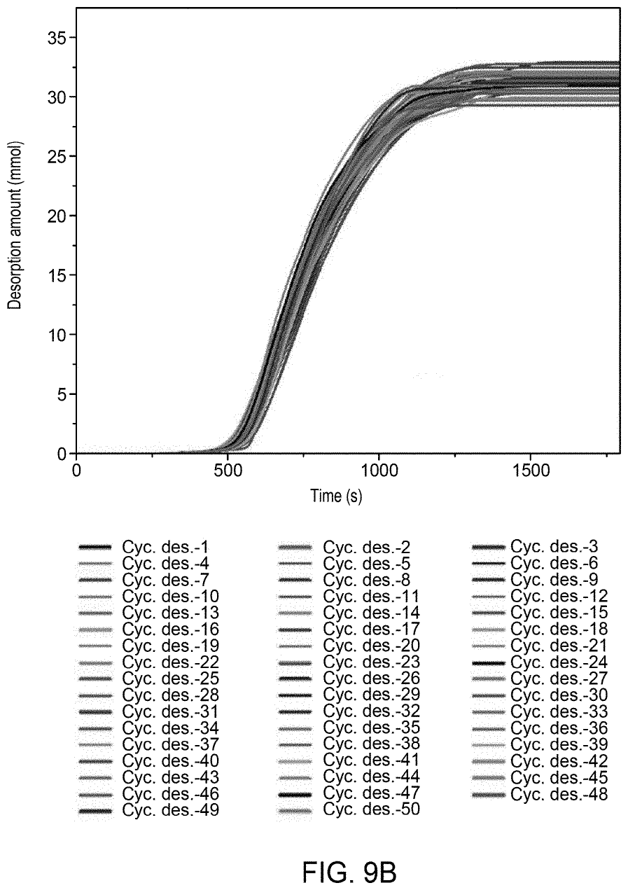

FIG. 9A shows exemplary data for the amount of CO₂ absorbed using an example composition over 50 absorption-desorption cycles according to at least one embodiment of the present disclosure.

FIG. 9B shows exemplary data for the amount of CO₂ desorbed using an example composition over 50 absorption-desorption cycles according to at least one embodiment of the present disclosure.

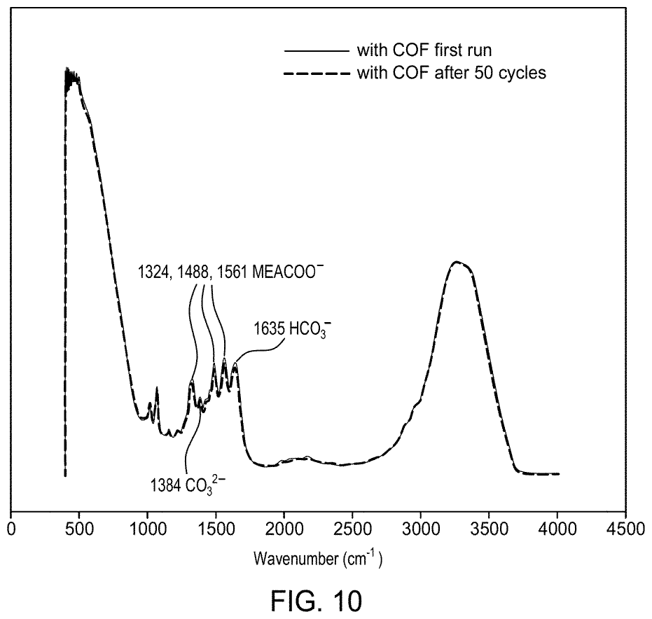

FIG. 10 shows exemplary FT-IR data showing bicarbonate (HCO₃⁻) species, carbonate (CO₃²⁻) species, and organic amine-COO⁻ (MEACOO⁻) species after subjecting an example composition to a single absorption-desorption cycle and 50 absorption-desorption cycles according to at least one embodiment of the present disclosure.

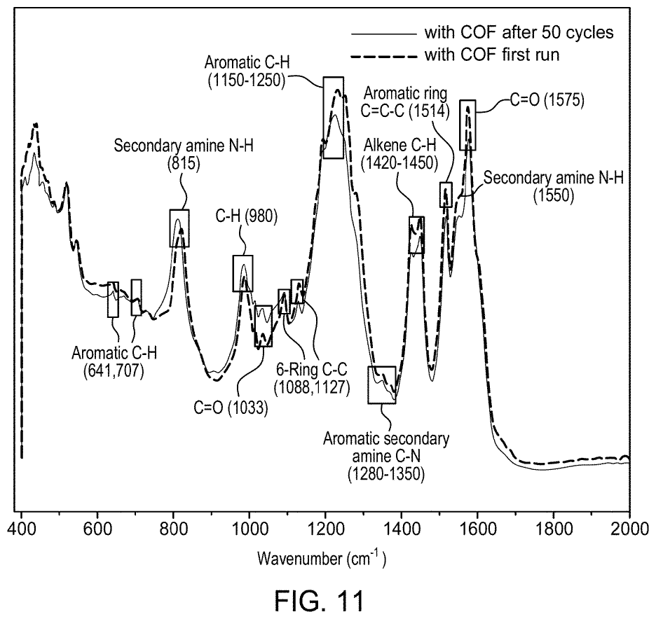

FIG. 11 shows exemplary FT-IR data for an example composition after a single absorption-desorption cycle and after 50 absorption-desorption cycles according to at least one embodiment of the present disclosure.

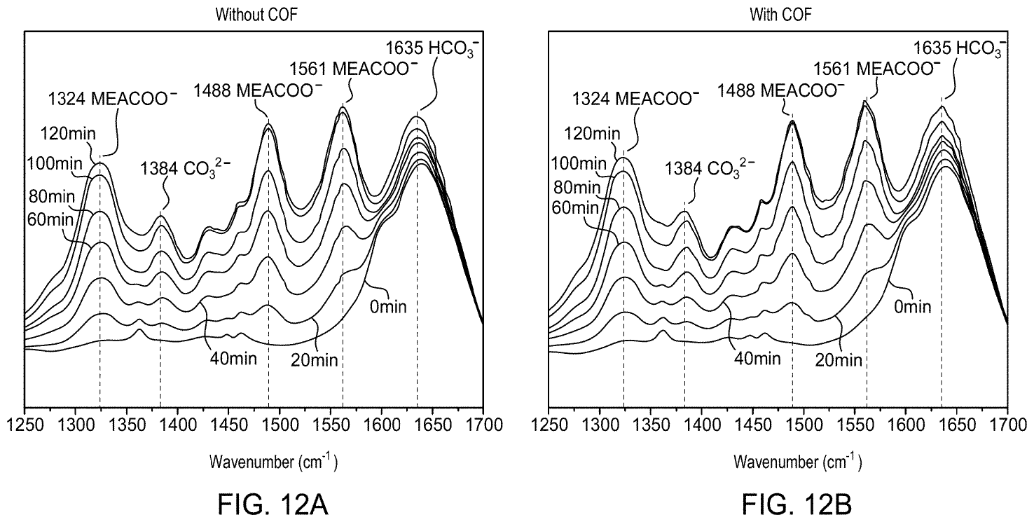

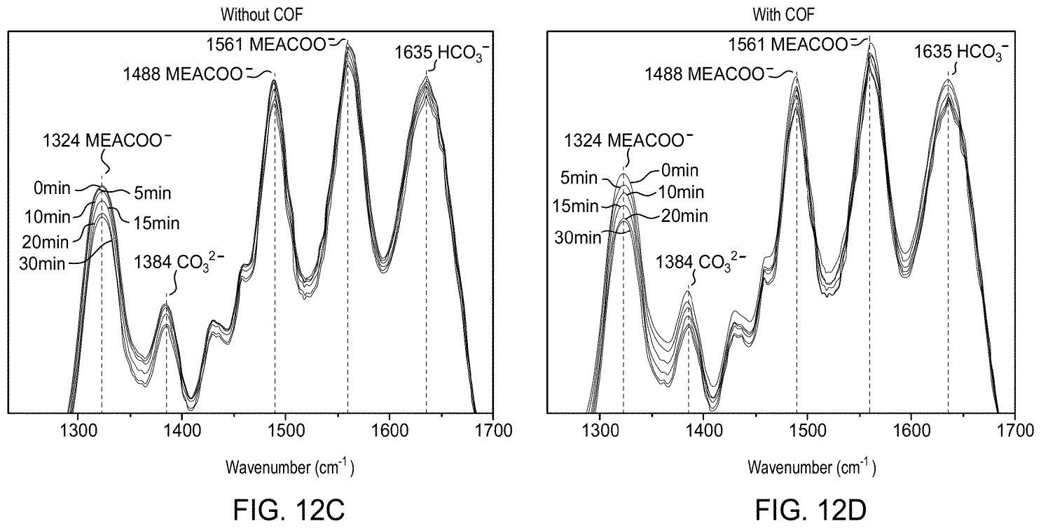

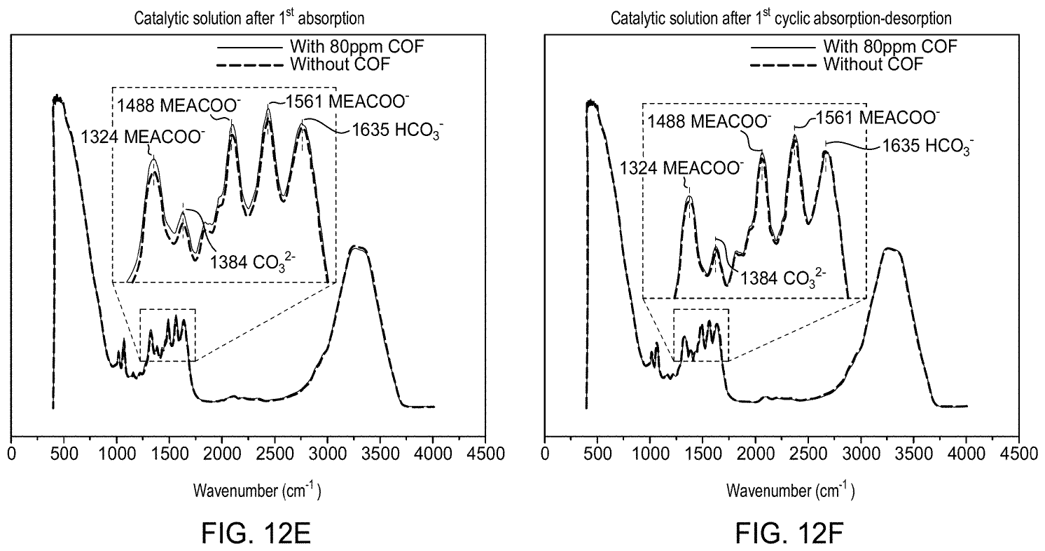

FIG. 12A shows FT-IR data for CO₂ absorption using a comparative example composition (without a COF catalyst).

FIG. 12B shows exemplary FT-IR data for CO₂ absorption using an example composition (with an example COF catalyst) according to at least one embodiment of the present disclosure.

FIG. 12C shows FT-IR data for CO₂ desorption using a comparative example composition (without a COF catalyst).

FIG. 12D shows exemplary FT-IR data for CO₂ desorption using an example composition (with an example COF catalyst) according to at least one embodiment of the present disclosure.

FIG. 12E shows exemplary FT-IR data after a single CO₂ absorption test using an example composition (with an example COF catalyst) and a comparative example composition (without a COF catalyst) according to at least one embodiment of the present disclosure.

FIG. 12F shows exemplary FT-IR data after a single CO₂ absorption-desorption cycle using an example composition (with an example COF catalyst) and a comparative example composition (without a COF catalyst) according to at least one embodiment of the present disclosure.

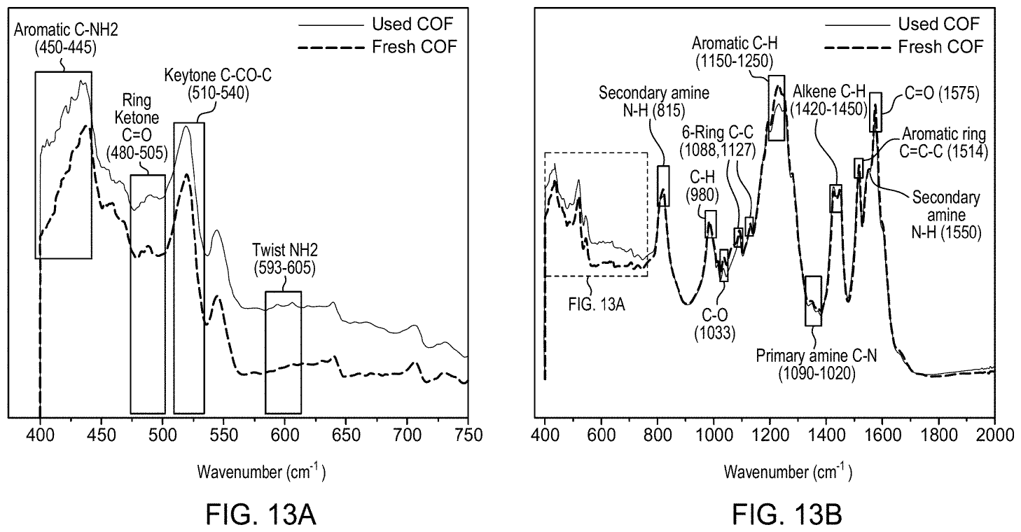

FIGS. 13A (spectral region of 400 cm⁻¹ to 750⁻¹) and 13B (spectral region of 400 cm⁻¹ to 2000⁻¹) show exemplary FT-IR data for an example COF catalyst with CO₂ absorption and without CO₂ absorption according to at least one embodiment of the present disclosure.

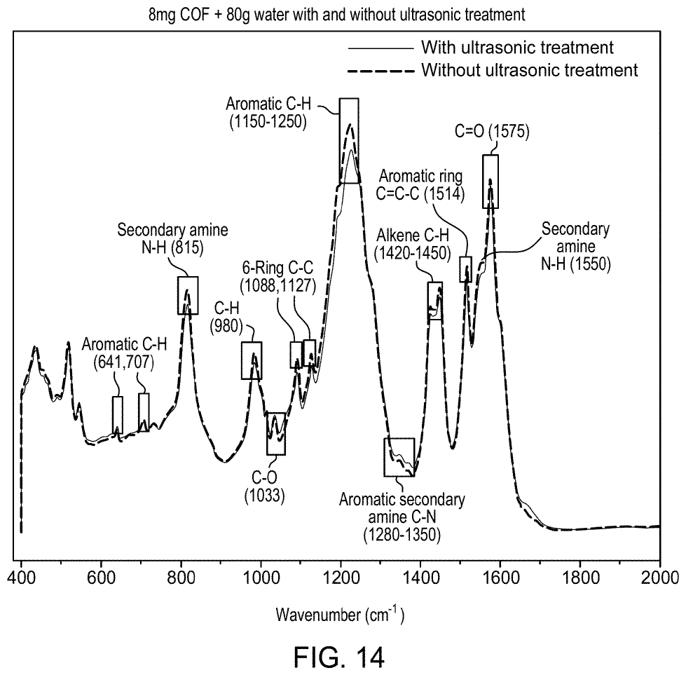

FIG. 14 shows exemplary FT-IR data of an example COF catalyst in water, with and without ultrasonic pretreatment, according to at least one embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein generally relate to compositions for CO₂ absorption and CO₂ desorption, and to processes for making such compositions. Embodiments described herein also generally relate to processes for CO₂ absorption and for CO₂ desorption.

Briefly, and in some embodiments, the compositions can include an organic amine and a carbon organic framework. The carbon organic framework (COF) accelerates and/or catalyzes both sorption and desorption from the organic amine (for example, monoethanolamine (MEA)). In some examples, the COF can be utilized at very low concentrations (for example, less than about 100 ppm, such as about 80 ppm). In some examples, even with the use of such low concentrations of catalysts, when the absorption achieves 90% CO₂ capture (the target from the U.S. Department of Energy (DOE) for CO₂ capture efficiency), the amount of CO₂ desorption can be increased by 305.1% at 85° C., which makes use of low-temperature waste heat and avoids secondary pollution during CO₂ capture feasible.

For purposes of the present disclosure, the term “carbon organic framework” is used interchangeably with the term “catalyst” such that reference to one includes reference to the other. For example, reference to carbon organic framework includes reference to both carbon organic framework and catalyst, and vice-versa. The carbon organic framework (and/or ion thereof) can serve to, for example, catalyze the absorption of CO₂ to the organic amine and/or catalyze the desorption of CO₂ from the organic amine. During sorption and/or desorption, one or more components of the composition can exist as ion(s).

For purposes of the present disclosure, the term “catalyst” refers to both [COOH]ₓ—COF and COF. Compositions can include varying amounts of an organic amine and varying amounts of a catalyst. Compositions described herein can include one or more additional components such as solvent, for example, water.

The use of headings is for purposes of convenience only and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

In solution or suspension, the carbon organic framework and/or the organic amine may exist as one or more ions in the composition. For example, the carbon organic framework (having ionizable groups, for example, —COOH, may exist in its ionic state). In some examples, at least a portion of the solvent can exist as an ion in the composition.

Embodiments of the present disclosure generally relate to compositions for absorbing, desorbing, and/or capturing of carbon dioxide (CO₂). Compositions described herein generally include a solution or suspension that includes an organic amine and a carbon organic framework. Compositions described herein can further include one or more additional components such as a solvent. Any suitable solvent such as water can be. The solvent may be used for solubilizing and/or suspending at least a portion of the carbon organic framework, the organic amine, or combinations thereof.

The carbon organic framework can serve to, for example, catalyze and/or accelerate absorption of CO₂, desorption of CO₂, and/or capture of CO₂ by the organic amine of the composition. The carbon organic framework useful for compositions described herein can comprise, consist essentially of, or consist of comprises one or more compounds represented by formula (I), an ion thereof, or combinations thereof:

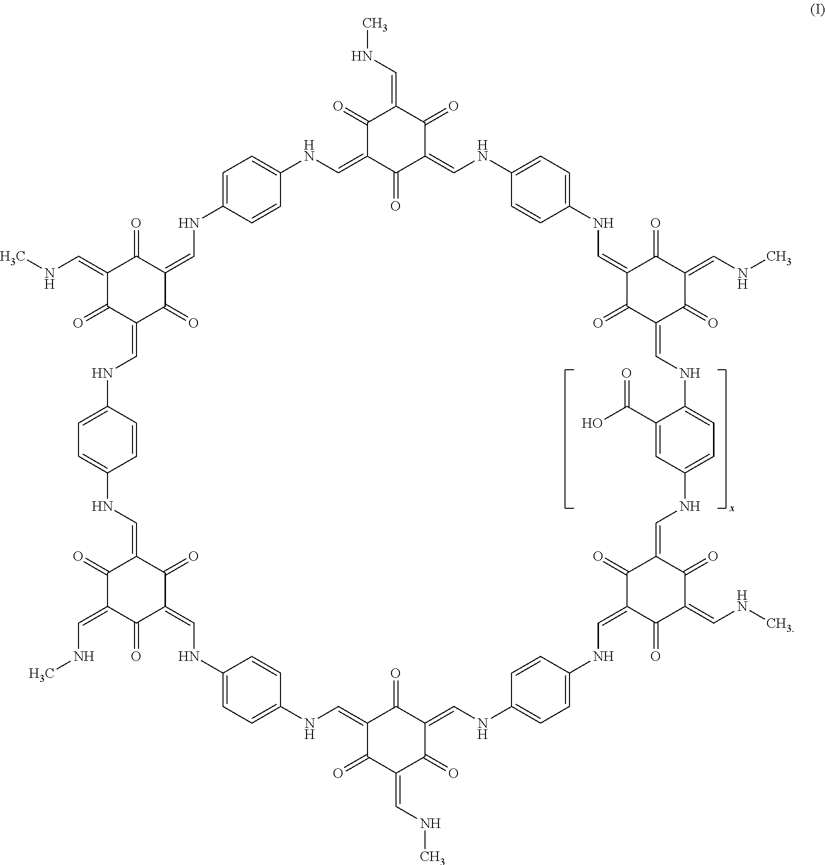

In some embodiments, x of formula (I) is any suitable number such as from 1 to 200, such as from 5 to 80, such as from 10 to 50, such as from 15 to 35. In at least one embodiment, x of formula (I) can be from 17 to 100, such as 17, 33, 50, 67, or 100. The carbon organic framework (also referred to as [COOH]x-COF) of formula (I) has a plurality of carboxylic acid groups that can be ionizable. Such ionizable carboxylic acid groups can be beneficial in generating organic amine-COO⁻ species (for example, MEACOO⁻), carbonate (CO₃²⁻) species, bicarbonate (HCO₃⁻) species, or combinations thereof, among others, during absorption and/or desorption of CO₂. More than one carbon organic framework can be utilized in compositions described herein if desired.

The organic amine can serve to, for example, capture and/or absorb CO₂. The organic amine(s) used in compositions described herein can include primary organic amine compounds, secondary organic amine compounds, tertiary organic amine compounds, or combinations thereof. More than one organic amine compound can be utilized in compositions described herein.

In some embodiments, the organic amine compound can include any suitable organic amine compound such as, for example, monoethanolamine (MEA), diethanolamine (DEA), triethanolamine (TEA), diisopropanolamine (DIPA), monomethyl-ethanolamine (MMEA), methyldiethanolamine (MDEA), diethyl-monoethanolamine (DEMEA), or combinations thereof. In at least one embodiment, the organic amine can include an amine-functionalized polymer such as a polyethylene amine. Illustrative, but non-limiting, examples of polyethylene amines can include diethylenetriamine (DETA), triethylenetetramine (TETA), tetraethylenepentamine (TEPA), tetraacetylethylenediamine (TAED), polyethylenehexamine such as pentaethylenehexamine (PEHA), polyethyleneimine (PEI), or combinations thereof.

A total weight percent (wt %) of the composition is based on a total amount (in wt %) of carbon organic framework, a total amount (in wt %) of organic amine, and a total amount (in wt %) of optional components. The total wt % of the composition does not exceed 100 wt %.

In some examples, a total amount of carbon organic framework in compositions described herein can be greater than 0 wt % and about 1 wt % (10,000 ppm) or less, such as about 0.5 wt % (5,000 ppm) or less, such as about 0.1 wt % (1,000 ppm) or less, such as about 0.075 wt % (750 ppm) or less based on a total weight of the composition. In at least one embodiment, the total amount of carbon organic framework in the composition can be 0.001 wt % (10 ppm), 0.002 wt % (20 ppm), 0.003 wt % (30 ppm), 0.004 wt % (40 ppm), 0.005 wt % (50 ppm), 0.006 wt % (60 ppm), 0.007 wt % (70 ppm), 0.008 wt % (80 ppm), 0.009 wt % (90 ppm), 0.01 wt % (100 ppm), 0.011 wt % (110 ppm), 0.012 wt % (120 ppm), 0.013 wt % (130 ppm), 0.014 wt % (140 ppm), 0.015 wt % (150 ppm), 0.016 wt % (160 ppm), 0.017 wt % (170 ppm), 0.018 wt % (180 ppm), 0.019 wt % (190 ppm), 0.02 wt % (200 ppm), 0.021 wt % (210 ppm), 0.022 wt % (220 ppm), 0.023 wt % (230 ppm), 0.024 wt % (240 ppm), 0.025 wt % (250 ppm), 0.026 wt % (260 ppm), 0.027 wt % (270 ppm), 0.028 wt % (280 ppm), 0.029 wt % (290 ppm), 0.03 wt % (300 ppm), 0.031 wt % (310 ppm), 0.032 wt % (320 ppm), 0.033 wt % (330 ppm), 0.034 wt % (340 ppm), 0.035 wt % (350 ppm), 0.036 wt % (360 ppm), 0.037 wt % (370 ppm), 0.038 wt % (380 ppm), 0.039 wt % (390 ppm), 0.04 wt % (400 ppm), 0.041 wt % (410 ppm), 0.042 wt % (420 ppm), 0.043 wt % (430 ppm), 0.044 wt % (440 ppm), 0.045 wt % (450 ppm), 0.046 wt % (460 ppm), 0.047 wt % (470 ppm), 0.048 wt % (480 ppm), 0.049 wt % (490 ppm), 0.05 wt % (500 ppm), 0.051 wt % (510 ppm), 0.052 wt % (520 ppm), 0.053 wt % (530 ppm), 0.054 wt % (540 ppm), 0.055 wt % (550 ppm), 0.056 wt % (560 ppm), 0.057 wt % (570 ppm), 0.058 wt % (580 ppm), 0.059 wt % (590 ppm), 0.06 wt % (600 ppm), 0.061 wt % (610 ppm), 0.062 wt % (620 ppm), 0.063 wt % (630 ppm), 0.064 wt % (640 ppm), 0.065 wt % (650 ppm), 0.066 wt % (660 ppm), 0.067 wt % (670 ppm), 0.068 wt % (680 ppm), 0.069 wt % (690 ppm), 0.07 wt % (700 ppm), 0.071 wt % (710 ppm), 0.072 wt % (720 ppm), 0.073 wt % (730 ppm), 0.074 wt % (740 ppm), 0.075 wt % (750 ppm), 0.076 wt % (760 ppm), 0.077 wt % (770 ppm), 0.078 wt % (780 ppm), 0.079 wt % (790 ppm), 0.08 wt % (800 ppm), 0.081 wt % (810 ppm), 0.082 wt % (820 ppm), 0.083 wt % (830 ppm), 0.084 wt % (840 ppm), 0.085 wt % (850 ppm), 0.086 wt % (860 ppm), 0.087 wt % (870 ppm), 0.088 wt % (880 ppm), 0.089 wt % (890 ppm), 0.09 wt % (900 ppm), 0.091 wt % (910 ppm), 0.092 wt % (920 ppm), 0.093 wt % (930 ppm), 0.094 wt % (940 ppm), 0.095 wt % (950 ppm), 0.096 wt % (960 ppm), 0.097 wt % (970 ppm), 0.098 wt % (980 ppm), 0.099 wt % (990 ppm), or 0.10 (1,000 ppm), or ranges thereof. Each of the foregoing numbers can be preceded by the word “about,” “at least about,” “less than about,” or “more than about” and any of the foregoing numbers can be used singly to describe an open-ended range or in combination to describe a close-ended range. For example, the total amount of carbon organic framework in the composition can be about 0.005 wt % (50 ppm) or more, about 0.005 wt % (50 ppm) to about 0.015 wt % (150 ppm), about 0.03 wt % (300 ppm) or less, or at least about 0.008 wt % (80 ppm). Other amounts are contemplated.

The amount of carbon organic framework used for the compositions can be based on the dry weight of the carbon organic framework (for example, the carbon organic framework without moisture).

In contrast to conventional CO₂ capture using carbon organic frameworks at high concentrations (for example, greater than 2,000 ppm or greater than 3,000 ppm), the carbon organic frameworks described herein can be utilized at much lower concentrations if desired.

In some examples, a total amount of organic amine in compositions described herein can be about 1 wt % or more and/or about 99 wt % or less, such as from about 5 wt % to about 95 wt %, such as from about 10 wt % to about 90 wt %, such as from about 15 wt % to about 85 wt %, such as from about 20 wt % to about 80 wt %, such as from about 25 wt % to about 75 wt %, such as from about 30 wt % to about 70 wt %, such as from about 35 wt % to about 65 wt %, such as from about 40 wt % to about 60 wt %, such as from about 45 wt % to about 55 wt %, based on a total weight of the composition. In at least one embodiment, the total amount (in wt %) of organic amine in compositions described herein can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 31, 32, 33, 34, 35, 36, 37, 38, 39, 41, 42, 43, 44, 45, 46, 47, 48, 49, 51, 52, 53, 54, 55, 56, 57, 58, 59, 61, 62, 63, 64, 65, 66, 67, 68, 69, 71, 72, 73, 74, 75, 76, 77, 78, 79, 81, 82, 83, 84, 85, 86, 87, 88, 89, 91, 92, 93, 94, 95, 96, 97, 98, or 99, or ranges thereof. Each of the foregoing numbers can be preceded by the word “about,” “at least about,” “less than about,” or “more than about” and any of the foregoing numbers can be used singly to describe an open-ended range or in combination to describe a close-ended range. For example, the amount (wt %) of organic amine in the composition is about 10 wt % or more, about 15 wt % to about 25 wt %, about 50 wt % or less, or at least about 20 wt %, based on a total weight of the composition. Other amounts are contemplated.

As described above, compositions described herein can include one or more additional components. The one or more additional components can include a solvent such as water. In some embodiments, the solvent (such as water) can be used in an amount to achieve 100 wt %. For example, and in some embodiments, a total mass of a composition can be about 100 g. This 100 g composition can include an organic amine (about 20 wt %), carbon organic framework (about 0.008 wt % (about 80 ppm), and the remainder solvent.

Embodiments of the present disclosure also generally relate to processes for making a composition for absorbing or desorbing CO₂. In general, compositions described herein can be made or formed by introducing the materials (the carbon organic framework, the organic amine, and optionally an additional component) of the composition to one another and mixing the materials. The carbon organic framework, the organic amine, and optionally an additional component, can be charged to a vessel and stirred, mixed, or otherwise agitated under mixing (or pretreatment) conditions effective to form a composition. “Pretreatment” refers to operations performed during and/or after formation of the composition, but before use of the composition for CO₂ absorption and/or CO₂ desorption

Pretreatment conditions can include mixing the components at a pressure of about 0.7 atm (about 70 kPa) to about 1.3 atm (about 130 kPa), such as from about 0.8 atm (about 80 kPa) to about 1.2 atm (about 120 kPa), such as from about 0.9 atm (about 90 kPa) to about 1.1 atm (about 110 kPa), though other pressures are contemplated. Any of the foregoing numbers can be used singly to describe an open-ended range or in combination to describe a close-ended range. Pretreatment conditions can include elevated temperatures if desired, such as from about 30° C. to about 50° C., such as from about 35° C. to about 45° C., though other temperatures are contemplated. Any of the foregoing numbers can be used singly to describe an open-ended range or in combination to describe a close-ended range.

Pretreatment conditions can include stirring, mixing, agitating, or combinations thereof components of the composition by using suitable devices such as a mechanical stirrer.

The pretreatment conditions can include use of suitable devices such as a mechanical stirrer (for example, an overhead stirrer), a magnetic stirrer (for example, placing a magnetic stir bar in the vessel above a magnetic stirrer), a sonicator, or other suitable devices. Sonication can be performed using an ultrasonic bath or an ultrasonic probe. Ultrasonic frequencies (for example, about 20 kHz or more) can be used for ultrasonication, though other ultrasonic frequencies are contemplated. In some examples, one or more components of the composition can be subjected to ultrasound. The ultrasound, in some embodiments, can have one or more of the following:

(a) A power for the ultrasonic pretreatment of 5 W to 15 W, such as from 7 W to 12 W, such as 7 W, 8 W, 9 W, 10 W, 11 W, or 12 W. Each of the foregoing numbers can be preceded by the word “about,” “at least about,” “less than about,” or “more than about” and any of the foregoing numbers can be used singly to describe an open-ended range or in combination to describe a close-ended range. Other power values are contemplated.

(b) A time of ultrasonic pretreatment of 1 min to 300 min, such as from 10 min to 180 min, such as from 20 min to 120 min, such as 30 min, 45 min, 60 min, 75 min, 90 min, or 120 min. Each of the foregoing numbers can be preceded by the word “about,” “at least about,” “less than about,” or “more than about” and any of the foregoing numbers can be used singly to describe an open-ended range or in combination to describe a close-ended range. Other periods are contemplated.

(c) A temperature during ultrasonic pretreatment of 10° C. to 70° C., such as from 20° C. to 60° C., such as from 30° C. to 50° C., such as 30° C., 35° C., 40° C., 45° C., or 50° C. Each of the foregoing numbers can be preceded by the word “about,” “at least about,” “less than about,” or “more than about” and any of the foregoing numbers can be used singly to describe an open-ended range or in combination to describe a close-ended range. Other temperatures are contemplated.

Pretreatment conditions can include elevated temperatures if desired, such as from about 30° C. to about 50° C., such as from about 35° C. to about 45° C., though other temperatures are contemplated. Any of the foregoing numbers can be used singly to describe an open-ended range or in combination to describe a close-ended range.

In some examples, two or more components of the composition can be subjected to mixing (for example, ultrasonication) prior to introducing the third component to the composition. For example, a mixture of the carbon organic framework and water can be subjected to ultrasonic treatment. The ultrasonically-treated mixture can be introduced with the organic amine to form a composition described herein. The ultrasonically-treated mixture and the one or more organic amines can be mixed by suitable methods such as those described above.

Embodiments of the present disclosure also generally relate to uses of compositions described herein. In some embodiments, compositions described herein can be utilized in processes for absorbing CO₂, desorbing CO₂, and/or capturing CO₂, or combinations thereof. Other uses are contemplated.

Briefly, and in some embodiments, CO₂ is present in a gas or a gas stream at any suitable concentration. The gas or gas stream is introduced and/or contacted with a composition described herein, and a CO₂-enriched composition is formed. The gas or gas stream can have any suitable amount of one or more additional gases. For example, the gas or gas stream can include CO₂ with one or more additional gases such as N₂ and/or O₂ in any suitable concentrations.

In some embodiments, a process for absorbing CO₂ and/or capturing CO₂ includes contacting or introducing, under absorption conditions, a gas or gas stream with a composition described herein to form a CO₂-enriched composition. The contacting, introducing, or combinations thereof can occur in an absorption unit. An example absorption unit is shown in FIG. 4 and is described below. The gas or the gas stream comprising can be fed to the headspace above the composition, fed into the composition (for example, via a bubbler or other appropriate apparatus), or combinations thereof.

The absorption conditions can include various temperatures, pressures, times, flow rates of the gas (or gas stream), combinations thereof, or other parameters suitable for absorption.

Absorption conditions can include stirring, mixing, or otherwise agitating the composition while contacting or introducing the gas stream with the composition. Stirring, mixing, agitating, or combinations thereof can be performed using any suitable device such as a mechanical stirrer (for example, an overhead stirrer), a magnetic stirrer (for example, placing a magnetic stir bar in the vessel above a magnetic stirrer), a sonicator, or other suitable devices.

Absorption conditions can include a pressure of about 0.7 atm (about 70 kPa) to about 1.3 atm (about 130 kPa), such as from about 0.8 atm (about 80 kPa) to about 1.2 atm (about 120 kPa), such as from about 0.9 atm (about 90 kPa) to about 1.1 atm (about 110 kPa). In some embodiments, the pressure (kPa) during absorption can be 70, 75, 80, 85, 90, 95, 100, 105, 110, 115, 120, 125, or 130, or ranges thereof. Each of the foregoing numbers can be preceded by the word “about,” “at least about,” “less than about,” or “more than about” and any of the foregoing numbers can be used singly to describe an open-ended range or in combination to describe a close-ended range. Other pressures are contemplated.

Absorption conditions can include heating the composition to a temperature of about 5° C. to about 100° C., such as from about 10° C. to about 90° C., such as from about 15° C. to about 85° C., such as from about 20° C. to about 80° C., such as from about 25° C. to about 75° C., such as from about 30° C. to about 70° C., such as from about 35° C. to about 65° C., such as from about 40° C. to about 60° C., such as from about 45° C. to about 55° C. In at least one embodiment, the composition can be heated at a temperature (° C.) of 5, 10, 15, 20, 25, 30, 35, 40, 45, 50, 55, 60, 65, 70, 75, 80, 85, 90, 95, or 100, or ranges thereof. Each of the foregoing numbers can be preceded by the word “about,” “at least about,” “less than about,” or “more than about” and any of the foregoing numbers can be used singly to describe an open-ended range or in combination to describe a close-ended range. Other temperatures are contemplated. The temperature of the composition can be monitored by a thermocouple as shown in the Examples.

Absorption conditions can include an absorption time. The absorption time is the period that begins with introducing the gas or the gas stream to the composition (for example, turning on the flow of the gas or gas stream) and ends with ceasing introduction of the gas or the gas stream (for example, stopping the flow of the gas or gas stream). The absorption time can be any suitable amount of time, such as about 1 minute (min) or more, about 72 hours (h) or less, or combinations thereof. In some embodiments, the absorption time can be from about 1 min to about 48 h, such as from about 5 min to about 24 h, such as from about 10 min to about 10 h, such as from about 30 min to about 5 h, such as from about 1 h to about 3 h, though other periods are contemplated. Any of the foregoing numbers can be used singly to describe an open-ended range or in combination to describe a close-ended range. In at least one embodiment, the absorption time can be from about 1 min to about 60 min, such as from about 5 min to about 45 min, such as from about 10 min to about 30 min, for example 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 min, or ranges thereof. Each of the foregoing numbers can be preceded by the word “about,” “at least about,” “less than about,” or “more than about” and any of the foregoing numbers can be used singly to describe an open-ended range or in combination to describe a close-ended range. Other periods are contemplated.

Absorption conditions can include a flow rate of the gas or gas stream that contacts or is introduced with the composition can be any suitable flow rate. In some embodiments, a flow rate of the gas or gas stream can be from about 50 mL/min to about 5,000 mL/min, such as from about 100 mL/min to about 4,500 mL/min, such as from about 250 mL/min to about 3,000 mL/min, such as from about 500 mL/min to about 2,000 mL/min, though other flow rates are contemplated. Any of the foregoing numbers can be used singly to describe an open-ended range or in combination to describe a close-ended range. In at least one embodiment, a flow rate of the gas or gas stream can be from about 10 mL/min to about 1,000 mL/min, such as from about 50 mL/min to about 950 mL/min, such as from about 100 mL/min to about 900 mL/min, such as from about 150 mL/min to about 850 mL/min, such as from about 200 mL/min to about 800 mL/min, such as from about 250 mL/min to about 750 mL/min, such as from about 300 mL/min to about 700 mL/min, such as from about 350 mL/min to about 650 mL/min, such as from about 400 mL/min to about 600 mL/min, such as from about 450 mL/min to about 550 mL/min, such as about 500 mL/min, though other flow rates are contemplated. Any of the foregoing numbers can be used singly to describe an open-ended range or in combination to describe a close-ended range.

The gas or gas stream that contacts the composition during absorption can comprise, consist essentially of, or consist of CO₂. When the gas or gas stream includes another gas besides CO₂, the amount of CO₂ in the gas or gas stream can be any suitable amount, such as about 0.01 volume percent (vol %) CO₂ or more, about 99.9 vol % CO₂ or less, or combinations thereof, based on a total vol % of the gas or gas stream, the total vol % of the gas or gas stream not to exceed 100 vol %. In some embodiments, the amount of CO₂ in the gas or gas stream can be about 1 vol % to about 100 vol %, such as from about 5 vol % to about 90 wt %, such as from about 10 vol % to about 80 vol %, such as from about 20 vol % to about 50 vol %, based on a total vol % of the gas or gas stream. In at least one embodiment, the amount (in vol %) of CO₂ in the gas or gas stream, based on the total vol % of the gas or gas stream, can be 0.01, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 31, 32, 33, 34, 35, 36, 37, 38, 39, 41, 42, 43, 44, 45, 46, 47, 48, 49, 51, 52, 53, 54, 55, 56, 57, 58, 59, 61, 62, 63, 64, 65, 66, 67, 68, 69, 71, 72, 73, 74, 75, 76, 77, 78, 79, 81, 82, 83, 84, 85, 86, 87, 88, 89, 91, 92, 93, 94, 95, 96, 97, 98, 99, 99.9, or 100, or ranges thereof. Each of the foregoing numbers can be preceded by the word “about,” “at least about,” “less than about,” or “more than about” and any of the foregoing numbers can be used singly to describe an open-ended range or in combination to describe a close-ended range. Other amounts are contemplated.

The gas or gas stream that contacts the composition during absorption can optionally include one or more additional gases such as nitrogen (N₂), oxygen (O₂), hydrogen (H₂), argon (Ar), helium (He), water (H₂O), or combinations thereof, among others. A total amount of the one or more optional gases in the gas or gas stream can be about 0.01 vol % or more, about 99.9 vol % or less, or combinations thereof, based on a total vol % of the gas or gas stream. In some embodiments, the total amount of the one or more optional gases in the gas or gas stream can be about 1 vol % to about 99 vol %, such as from about 50 vol % to about 95 wt %, such as from about 75 vol % to about 90 vol %, such as from about 80 vol % to about 85 vol %, based on a total vol % of the gas or gas stream. In at least one embodiment, the total amount (in vol %) of the one or more optional gases in the gas or gas stream, based on the total vol % of the gas or gas stream, can be 0.01, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 31, 32, 33, 34, 35, 36, 37, 38, 39, 41, 42, 43, 44, 45, 46, 47, 48, 49, 51, 52, 53, 54, 55, 56, 57, 58, 59, 61, 62, 63, 64, 65, 66, 67, 68, 69, 71, 72, 73, 74, 75, 76, 77, 78, 79, 81, 82, 83, 84, 85, 86, 87, 88, 89, 91, 92, 93, 94, 95, 96, 97, 98, 99, 99.9, or ranges thereof. Each of the foregoing numbers can be preceded by the word “about,” “at least about,” “less than about,” or “more than about” and any of the foregoing numbers can be used singly to describe an open-ended range or in combination to describe a close-ended range. Other amounts are contemplated. Each of the foregoing numbers can be used to describe the amount of one optional gas or the amount of multiple optional gases.

In at least one embodiment, a gas or gas stream for absorption comprises, consists essentially of, or consists of CO₂, N₂, and O₂. An amount of CO₂ in the gas or gas stream can be from about 1 vol % to about 40 vol %, such as from about 5 vol % to about 15 vol %, such as those amounts described above; an amount of N₂ in the gas or gas stream can be from about 59 vol % to about 99 vol %, such as from about 75 vol % to about 85 vol %, such as those amounts described above; and the remainder can be O₂, such as from about 5 vol % to about 15 vol %, such as those amounts described above.

Absorption of CO₂ by compositions described herein can be performed according to the following non-limiting procedure. A composition described herein can be placed in a vessel equipped with a mechanical stirrer. CO₂ or a gas stream comprising CO₂ can be fed to the vessel at a selected flow rate (for example, about 500 mL/min) while the composition is stirring. The CO₂ or a gas stream comprising CO₂ can be fed to the headspace above the composition, fed into the composition (for example, via a bubbler or other appropriate apparatus), or combinations thereof. Absorption can be performed for about 30 minutes.

After absorption of CO₂ by the composition from the gas or gas stream, a CO₂-enriched composition is formed. In some embodiments, at least a portion of the CO₂ in the CO₂-enriched composition can be desorbed (for example, removed or otherwise separated) from the CO₂-enriched composition under desorption conditions. Such desorption can be performed in a desorption unit. The desorption unit can be the same unit as the absorption unit or a different unit. Additionally, or alternatively, the CO₂-enriched composition can be passed to a separate desorption unit for the desorption operation. An example desorption unit is shown in FIG. 4 and is described below. Desorption conditions can include various temperatures, pressures, times, flow rates of gases into the desorption unit, and/or other parameters suitable for desorption. After at least a portion of the CO₂ is desorbed, removed, or otherwise separated from the CO₂-enriched composition, a CO₂-depleted composition is formed. The CO₂-depleted composition can still contain an amount of CO₂.

Desorption conditions can include stirring, mixing, or otherwise agitating the CO₂-enriched composition. Stirring, mixing, agitating, or combinations thereof can be performed using any suitable device such as a mechanical stirrer (for example, an overhead stirrer), a magnetic stirrer (for example, placing a magnetic stir bar in the vessel above a magnetic stirrer), a sonicator, or other suitable devices.

Desorption conditions can include a pressure of about 0.7 atm (about 70 kPa) to about 1.3 atm (about 130 kPa), such as from about 0.8 atm (about 80 kPa) to about 1.2 atm (about 120 kPa), such as from about 0.9 atm (about 90 kPa) to about 1.1 atm (about 110 kPa). In some embodiments, the pressure (kPa) during desorption can be 70, 75, 80, 85, 90, 95, 100, 105, 110, 115, 120, 125, or 130, or ranges thereof. Each of the foregoing numbers can be preceded by the word “about,” “at least about,” “less than about,” or “more than about” and any of the foregoing numbers can be used singly to describe an open-ended range or in combination to describe a close-ended range. Other pressures are contemplated.

Desorption conditions can include heating the CO₂-enriched composition to a temperature that is at or below a boiling point of a component of the composition (for example, at or below a boiling point of the organic amine or at or below a boiling point of the solvent). In some embodiments, desorption can be performed at a temperature of about 5° C. to about 100° C., such as from about 10° C. to about 90° C., such as from about 15° C. to about 85° C., such as from about 20° C. to about 80° C., such as from about 25° C. to about 75° C., such as from about 30° C. to about 70° C., such as from about 35° C. to about 65° C., such as from about 40° C. to about 60° C., such as from about 45° C. to about 55° C. In at least one embodiment, the CO₂-enriched composition can be heated at a temperature (° C.) of 5, 10, 15, 20, 25, 30, 35, 40, 45, 50, 55, 60, 65, 70, 75, 80, 85, 90, 95, or 100, or ranges thereof. Each of the foregoing numbers can be preceded by the word “about,” “at least about,” “less than about,” or “more than about” and any of the foregoing numbers can be used singly to describe an open-ended range or in combination to describe a close-ended range. Other temperatures are contemplated. The temperature can be monitored by a thermocouple as shown in the Examples.

During desorption, the CO₂-enriched composition can be contacted or introduced with a carrier gas. The carrier gas can be used to facilitate removal of CO₂ from the CO₂-enriched composition. This carrier gas, can include nitrogen (N₂), oxygen (O₂), hydrogen (H₂), argon (Ar), helium (He), water (H₂O), or combinations thereof, among others. The carrier gas can be a single gas or a mixture of gases in any suitable proportions.

A flow rate of the carrier gas that contacts or is introduced with the CO₂-enriched composition can be any suitable flow rate. In some embodiments, a flow rate of the carrier gas can be from about 50 mL/min to about 5,000 mL/min, such as from about 100 mL/min to about 4,500 mL/min, such as from about 250 mL/min to about 3,000 mL/min, such as from about 500 mL/min to about 2,000 mL/min, though other flow rates are contemplated. Any of the foregoing numbers can be used singly to describe an open-ended range or in combination to describe a close-ended range. In at least one embodiment, a flow rate of the carrier gas can be from about 10 mL/min to about 1,000 mL/min, such as from about 50 mL/min to about 950 mL/min, such as from about 100 mL/min to about 900 mL/min, such as from about 150 mL/min to about 850 mL/min, such as from about 200 mL/min to about 800 mL/min, such as from about 250 mL/min to about 750 mL/min, such as from about 300 mL/min to about 700 mL/min, such as from about 350 mL/min to about 650 mL/min, such as from about 400 mL/min to about 600 mL/min, such as from about 450 mL/min to about 550 mL/min, such as about 500 mL/min, though other flow rates are contemplated. Any of the foregoing numbers can be used singly to describe an open-ended range or in combination to describe a close-ended range.

Desorption conditions can include a desorption time. The desorption time can be any suitable amount of time, such as about 1 minute (min) or more, about 72 hours (h) or less, or combinations thereof. In some embodiments, the desorption time can be from about 1 min to about 48 h, such as from about 5 min to about 24 h, such as from about 10 min to about 10 h, such as from about 30 min to about 5 h, such as from about 1 h to about 3 h, though other periods are contemplated. Any of the foregoing numbers can be used singly to describe an open-ended range or in combination to describe a close-ended range. In at least one embodiment, the desorption time can be from about 1 min to about 120 min, such as from about 10 min to about 90 min, such as from about 20 min to about 60 min, for example 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, or 120 min, or ranges thereof. Each of the foregoing numbers can be preceded by the word “about,” “at least about,” “less than about,” or “more than about” and any of the foregoing numbers can be used singly to describe an open-ended range or in combination to describe a close-ended range. Other periods are contemplated.

Desorption of CO₂ from the CO₂-enriched composition can be performed according to the following non-limiting procedure. The CO₂-enriched composition can be placed in a vessel equipped with a mechanical stirrer and can be heated at a temperature of about 85° C. A carrier gas (for example, N₂) can be fed to the vessel at a selected flow rate (for example, about 500 mL/min) while the CO₂-enriched composition is stirring. Desorption can be performed for about 30 minutes to about 60 minutes.

After desorption, removal, or separation of CO₂ from the CO₂-enriched composition, a CO₂-depleted composition is formed. The CO₂-depleted composition can still contain an amount of CO₂.

In some embodiments, after desorbing, removing, or otherwise separating CO₂ from the CO₂-enriched composition to form the CO₂-depleted composition, a composition described herein can be regenerated from at least a portion of the CO₂-depleted composition and then be used to absorb or capture CO₂. Additionally, or alternatively, at least a portion of the CO₂-depleted composition can be recycled to the absorption unit where it can be used to absorb or capture CO₂.

The following examples are put forth so as to provide those of ordinary skill in the art with a complete disclosure and description of how to make and use aspects of the present disclosure, and are not intended to limit the scope of aspects of the present disclosure. Efforts have been made to ensure accuracy with respect to numbers used (for example, amounts, dimensions, etc.) but some experimental errors and deviations should be accounted for.

### Examples

As used in the examples, the term “catalyst” refers to both [COOH]x-COF or COF. Compositions in the non-limiting examples can include varying amounts of monoethanolamine (MEA) (for example, about 20 wt % MEA), varying amounts of the catalyst (the COF), and a solvent (for example, water). The MEA serves to, for example, capture CO₂.

FT-IR spectra were collected with a Thermo Nicolet Magna IR 760 spectrometer. Thermal gravimetric analysis (TGA) was obtained using a thermal gravimetric analyzer. The TGA process settings were as follows: (1) a heating ramp of about 5° C./min within the temperature range of about 20-100° C. with a nitrogen flow rate of about 60 mL/min; (2) held isothermally at about 100° C. for about 180 min with a nitrogen flow rate of about 60 mL/min; (3) a heating ramp of about 5° C./min within the temperature range of about 100-600° C. with a nitrogen flow rate of about 60 mL/min.

FIG. 1 shows a reaction diagram 100 for forming [COOH]ₓ—COF 110 (formula I), wherein x of formula (I) is 17, 33, 50, 67, or 100. The carbon organic framework can be made by mixing 2,4,6-trihydroxybenzene-1,3,5-tricarbaldehyde (102) (CAS No. 34374-88-4), 2,5-diaminobenzoic acid (104) (CAS No. 610-74-2), and p-phenylenediamine (106) (CAS No. 106-50-3), under reaction conditions 108. Reaction conditions can include adding an acid (such as a acetic acid) to the mixture and reacting the resultant mixture at a temperature of about 120° C. until the desired amount of conversion to [COOH]ₓ—COF 110.

The non-limiting examples described herein utilize a [COOH]17-COF catalyst as a catalyst for CO₂ absorption and desorption.

FIG. 2 shows a FT-IR spectrum of the [COOH]₁₇—COF catalyst before any CO₂ absorption or desorption tests (“fresh COF”). The FT-IR spectrum was collected with a resolution of 4 cm⁻¹ by scanning 64 times from 4000 cm⁻¹ to 400 cm⁻¹. The peaks at about 815 cm⁻¹ and about 1550 cm⁻¹ are both assigned to —N—H (secondary amines, the vinylic and aromatic secondary amines). The peak at about 980 cm⁻¹ is assigned to —C—H, the peak at about 1033 cm⁻¹ is assigned to C—O, and the peaks at about 1088 cm⁻¹ and about 1127 cm⁻¹ are assigned to —C—C-(6-Ring). The peaks at about 1150-1250 cm⁻¹ is assigned to C—H (aromatic ring), and the peaks at about 1280-1350 cm⁻¹ are assigned to —C—N-(aromatic secondary amine), and the peaks at about 1420-1450 cm⁻¹ are assigned to C═C—H (alkene). The peak at about 1514 cm⁻¹ is assigned to C═C—C (aromatic ring), and the peak at about 1575 cm⁻¹ is assigned to C═O.

TGA was utilized to determine the water content of the [COOH]₁₇—COF catalyst. As shown in FIG. 3, the water content of the [COOH]₁₇—COF catalyst is about 20%. The TGA test also showed that the [COOH]₁₇—COF catalyst is stable at temperatures of about 130° C. under the conditions of the TGA test. The water present in the [COOH]₁₇—COF catalyst can be removed by, for example, placing the [COOH]₁₇—COF catalyst under vacuum.

CO₂ absorption and desorption investigations were performed utilizing the example apparatus 400 shown in FIG. 4. The example apparatus 400 includes a reactor 401 positioned in a furnace or heater 402 utilized to heat the reactor 401. A thermocouple 404 is utilized to monitor the temperature of a composition 403 (for example, a composition described herein such as a composition to absorb CO₂, a CO₂-enriched composition, among others) during, for example, absorption and desorption. A mechanical stirrer 405 is utilized to stir the composition 403.

A gas inlet 406 is positioned in the reactor 401 such that a gas (or mixture of gases) can be introduced into the composition 403 (below the top surface of the composition 403). Alternatively, or additionally, the gas inlet 406 can be positioned above the composition 403 (above the top surface of the composition 403) such that the gas (or mixture of gases) can be fed into the headspace above the composition 403. The gas (or mixture of gases) can be fed to the composition 403 through the gas inlet 406 from N₂ cylinder 411, 02 cylinder 412, a CO₂ cylinder 413 via a mass flow controller 410. The mass flow controller 410 is utilized to control the flow rate of the individual gases from the gas cylinders 411-413 to the reactor 401.

A condenser 407a is positioned above, and is coupled to, the reactor 401. The condenser 407a has a cooling liquid inlet and a cooling liquid outlet coupled to a cooling liquid unit 407b. Gas exits the reactor 401 through outlet 408 via a tube 409. The tube is coupled to a moisture remover 414 to remove moisture from the gas exiting the reactor 401. The moisture remover 414 is coupled to an in-line gas analyzer 415. The gas analyzer 415 is utilized to measure concentrations of gases in the gas exiting the reactor 401. The gas analyzer is coupled to a data recording unit 416 (for example, a computer)

### A. Non-Limiting Effects of the Synthesized [COOH]₁₇—COF Catalyst

The [COOH]₁₇—COF catalyst was synthesized as described above. FIGS. 5A-5D show exemplary data for the catalytic effects of the [COOH]₁₇—COF catalyst dosage on the CO₂ absorption and desorption process. Specifically, FIG. 5A and FIG. 5C show the amount of CO₂ absorption and rate of CO₂ absorption, respectively, using different amounts (dosages) of the [COOH]17-COF catalyst. FIGS. 5B and 5D show the amount of CO₂ desorption and rate of CO₂ desorption, respectively, using different amounts (dosages) of the [COOH]₁₇—COF catalyst.

The example compositions used for the data shown in FIGS. 5A-5D had the following characteristics: the total mass of solution was about 100 g and was made from MEA (about 20 wt %), varying amounts of the [COOH]₁₇—COF catalyst—about 0 ppm, about 40 ppm, about 75 ppm, about 100 ppm, about 125 ppm, and about 150 ppm, —with the remainder water. For the CO₂ absorption data shown in FIGS. 5A and 5C, the absorption conditions included: an inlet gas flow rate of about 500 mL/min; an inlet gas composition of about 80 vol % N₂, about 10 vol % CO₂, and about 10 vol % 02; and an absorption time of about 7200 seconds (s). For the CO₂ desorption data shown in FIGS. 5B and 5D, the desorption conditions included: a carrier gas (N₂) flow rate of about 500 mL/min; a temperature (measured by thermocouple) of about 85° C.; and a desorption time of about 1800 s.

The data shown in FIGS. 5A-5D indicated that, under the conditions tested, the dosage of the [COOH]₁₇—COF catalyst for accelerating CO₂ desorption, a key step for reducing overall CO₂ capture energy consumption, can be about 80 ppm (without moisture), though other concentrations of the [COOH]₁₇—COF catalyst are contemplated.

FIG. 6A and FIG. 6B show exemplary data for the CO₂ absorption and desorption performance of MEA solution catalyzed by the [COOH]₁₇—COF catalyst with and without ultrasonic pretreatments. Specifically, FIG. 6A shows the effect of the catalyst on the CO₂ absorption amount and (Cᵢₙ−Cₒᵤₜ)/Cᵢₙ, and FIG. 6B shows the effect of the catalyst on the CO₂ desorption amount and rate under the conditions tested. In the data, “without catalyst” refers to the CO₂ absorption-desorption without [COOH]₁₇—COF, “with 80 ppm COF” refers to the CO₂ absorption-desorption using the example composition that was not ultrasonically pretreated, and “with 80 ppm US—COF” refers to the CO₂ absorption-desorption using the example composition that was ultrasonically pretreated. The composition without catalyst (a comparative) utilized for the data shown in FIGS. 6A and 6B had the following characteristics: the total mass of solution was about 100 g and was made from MEA (about 20 wt %), with the remainder water. The example compositions utilized for the data shown in FIGS. 6A and 6B had the following characteristics: the total mass of solution was about 100 g and was made from MEA (about 20 wt %), about 80 ppm of [COOH]₁₇—COF catalyst, and the remainder water.

For the CO₂ absorption data shown in FIG. 6A, the absorption conditions included: an inlet gas flow rate of about 500 mL/min; an inlet gas composition of about 80 vol % N₂, about 10 vol % CO₂, and about 10 vol % 02; and an absorption time of about 7200 s. For the CO₂ desorption data shown in FIG. 6B, the desorption conditions included: a carrier gas (N₂) flow rate of about 500 mL/min; a temperature (measured by thermocouple) of about 85° C.; and a desorption time of about 1800 s.

Overall, the data indicated that both the [COOH]₁₇—COF catalyst, with or without ultrasonic pretreatment, can promote CO₂ absorption and desorption. As shown in FIG. 6A, when the absorption was sustained above 100% CO₂ capture efficiency, the 20 wt % MEA sorbent without the [COOH]₁₇—COF catalyst absorbed only about 54.7 mmol CO₂ with 100% CO₂ capture within the shorter absorption time of about 1,719 s. In contrast, the sorbent with the [COOH]₁₇—COF catalyst and can absorb about 164.8 mmol CO₂ (without ultrasonic pretreatment) and about 175.7 mmol CO₂ (with ultrasonic pretreatment). This represents an absorption amount improvement of about 201.3% (without ultrasonic pretreatment) and an absorption amount improvement of about 221.2% (with ultrasonic pretreatment) compared to the sorbent without catalyst. The corresponding absorption times were extended to about 4,949 s (without ultrasonic pretreatment) and about 5,290 s (with ultrasonic pretreatment), which represent absorption improvements of about 187.9% and about 207.7%, respectively, compared to the sorbent without catalyst.

FIG. 6B shows the catalytic effects of the [COOH]₁₇—COF catalyst on the CO₂ desorption amount and rate. This was tested with the spent 20 wt % MEA sorbent resulting from 7200 s of CO₂ absorption (the spent compositions resulting from the experiments of FIG. 6A)

The data shown in FIG. 6B indicated that the [COOH]₁₇—COF catalyst, with or without ultrasonic pretreatment, can significantly move the maximum CO₂ desorption rate point to earlier times, and can also increase the rates of CO₂ desorption from the MEA solutions when the absorption time is about 7200 s. Under the conditions tested, the times for reaching the maximum CO₂ desorption rate were shortened by about 172 s (without ultrasonic pretreatment) and about 230 s (with ultrasonic pretreatment) relative to the time required for CO₂ desorption without the use of the COF catalysts.

The peak desorption rate improvement was determined to be about 68.8% (without ultrasonic pretreatment) and about 106.3% (with ultrasonic pretreatment). Meanwhile, the quantities of CO₂ desorbed from the uncatalyzed solution, the catalytic solution without ultrasonic pretreatment, and the catalytic solution with ultrasonic pretreatment were determined to be about 17.13 mmol, about 23.16 mmol, and about 26.3 mmol, respectively.

FIGS. 7A and 7B show the CO₂ absorption and desorption performances of an MEA solution without a catalyst and an example ultrasonically pretreated composition having about 80 ppm of the [COOH]₁₇—COF catalyst when the absorption processes are terminated with 90% CO₂ capture efficiency. This 90% CO₂ capture efficiency is the target set by the U.S. Department of Energy (DOE). Specifically, FIG. 7A shows the effect of the catalyst on the CO₂ absorption amount and (Cᵢₙ−Cₒᵤₜ)/Cᵢₙ, and FIG. 7B shows the effect of the catalyst on the CO₂ desorption rate.

The catalyzed solution and uncatalyzed solution for the data of FIGS. 7A and 7B were made as described above for FIGS. 6A and 6B. The absorption conditions included: an inlet gas flow rate of about 500 mL/min; an inlet gas composition of about 80 vol % N₂, about 10 vol % CO₂, and about 10 vol % O₂; and an absorption time equivalent to the outlet CO₂ concentrations of about 1.1 vol %. The desorption conditions included: a carrier gas (N₂) flow rate of about 500 mL/min; a temperature (measured by thermocouple) of about 85° C.; and a desorption time of about 1800 s.

As shown in FIG. 7A, use of the example ultrasonically pretreated composition having the COF catalyst significantly promoted the CO₂ absorption by MEA. Here, the amount of CO₂ absorbed was determined to be about 214.7 mmol with an absorption time of about 6451 s. In contrast, when the solution does not include the COF catalyst, the MEA can only absorb about 202.4 mmol with a shorter absorption time of about 6114 s. As shown in FIG. 7B, the total amounts of CO₂ desorbed were determined to be about 10.37 mmol and about 2.56 mmol for the catalyzed and uncatalyzed solutions, respectively. That is, catalysts described herein can significantly increase the total amount of desorbed CO₂ by about 305.1%.

Overall, the data shown in FIGS. 7A and 7B indicated that when the absorption achieves 90% CO₂ capture (or the outlet CO₂ concentrations of both uncatalyzed and catalyzed CO₂ absorption are about 1.1 vol %), use of the example ultrasonically pretreated composition having the COF catalyst can promote both CO₂ absorption and the CO₂ desorption.

Notably, the catalyst dosage was only about 80 ppm under the conditions tested. This is the lowest catalyst dosage to be reported for achieving such a significant effect on the catalytic capture of CO₂. Therefore, the experimental results demonstrate that, for example, catalysts described herein are very effective for catalyzing CO₂ absorption and CO₂ desorption.

### B. Non-Limiting Data on the Stabilities of the Catalytic CO₂ Capture System

FIGS. 8, 9A, and 9B show the stability of example compositions over 50 absorption-desorption cycles. The composition, also referred to as the “capture system,” includes MWA, the [COOH]₁₇—COF catalyst, and water.

For the data shown in FIG. 8, the example ultrasonically pretreated composition had the following characteristics: the total mass of solution was about 100 g and was made from MEA (about 20 wt %), about 100 ppm of US—[COOH]₁₇—COF catalyst, with the remainder water. The absorption conditions for each absorption-desorption cycle included: an inlet gas flow rate of about 500 mL/min; an inlet gas composition of 80 vol % N₂, about 10 vol % CO₂, and about 10 vol % 02; and an absorption time of about 1800 s. The desorption conditions for each absorption-desorption cycle included: a carrier gas (N₂) flow rate of about 500 mL/min; a temperature (measured by thermocouple) of about 85° C.; and a desorption time of about 1800 s.

As shown in FIG. 8, it was determined that the example composition, under the conditions tested, had an average absorption amount of about 30.39 mmol and an average desorption amount of about 31.02 mmol over the 50 absorption-desorption cycles. This result indicated that the compositions described herein are very stable over multiple absorption-desorption cycles.

FIGS. 9A and 9B show exemplary data for the amount of CO₂ absorption and CO₂ desorption using an example composition. The example composition had the following characteristics: the total mass of solution was about 100 g and was made from MEA (about 20 wt %), about 80 ppm of [COOH]₁₇—COF catalyst, with the remainder water. The absorption conditions for each absorption-desorption cycle included: an inlet gas flow rate of about 500 mL/min; an inlet gas composition of 80 vol % N₂, about 10 vol % CO₂, and about 10 vol % O₂; and an absorption time of about 1800 s. The desorption conditions for each absorption-desorption cycle included: a carrier gas (N₂) flow rate of about 500 mL/min; a temperature (measured by thermocouple) of about 85° C.; and a desorption time of about 1800 s. No significant decrease in the amount of CO₂ absorbed or the amount of CO₂ desorbed was observed as illustrated by the data.

Overall, the results shown in FIGS. 8, 9A, and 9B demonstrated that there was no significant decrease in the amount of CO₂ absorbed or CO₂ desorbed. Such results indicate that compositions (or capture systems) described herein can be stable over at least 50 absorption-desorption cycles.

FIG. 10 shows a comparison of the FT-IR spectra of an example composition—20 wt % MEA aqueous solution, 80 ppm of the [COOH]₁₇—COF catalyst, and the remainder water-after a single absorption-desorption cycle and after 50 absorption-desorption cycles. The spectra show that bicarbonate (HCO₃⁻) species, carbonate (CO₃²⁻) species, and organic amine-COO⁻ (MEACOO⁻) species are generated during the CO₂ absorption process. The results indicate that no change was observed for the structure of MEA molecules after 50 cyclic absorption-desorption cycles.

FIG. 11 shows a comparison of FT-IR spectra of an example composition-20 wt % MEA aqueous solution, 80 ppm of the [COOH]₁₇—COF catalyst, and the remainder water-after a single absorption-desorption cycle and after 50 absorption-desorption cycles. Here, the [COOH]₁₇—COF catalyst was filtered, washed, and dried before collecting each FT-IR spectrum. No new peak appeared in the FT-IR spectra of the [COOH]₁₇—COF catalyst after 50 absorption-desorption cycles, indicating that there was no change in the catalyst structure.

Overall, the data shown in FIGS. 10 and 11 indicate that both the MEA solution and the [COOH]₁₇—COF catalyst remain stable after at least 50 absorption-desorption cycles. The results also indicate that the MEA solution and the [COOH]₁₇—COF catalyst are reusable for CO₂ capture. That is, compositions described herein can be stable and reusable.

### C. Non-Limiting Mechanism

### C.1. Confirmation of COF Catalysis Effect by FT-IR Spectroscopy of the Solution Portion of the Composition

As described above, the catalytic effect of the [COOH]₁₇—COF catalyst in the MEA aqueous solutions (with and without ultrasonic pretreatment) was clearly observed with the significant enhancement of CO₂ absorption and CO₂ desorption. The associated mechanism was also investigated. To this end, FI—IR spectroscopy was utilized to investigate the catalytic effect of the [COOH]₁₇—COF catalyst on CO₂ absorption and desorption.

FIGS. 12A-12F show FT-IR spectra of a catalyzed solution (80 ppm [COOH]₁₇—COF catalyst, 20 wt % MEA, with remainder water) and an uncatalyzed solution (20 wt % MEA in water) at different times during CO₂ absorption and CO₂ desorption. Specifically, FIG. 12A and FIG. 12B show the FT-IR spectra for CO₂ absorption using the uncatalyzed solution (without COF) and the catalyzed solution (with COF), respectively.

FIG. 12C and FIG. 12D show FT-IR spectra for CO₂ desorption using the uncatalyzed solution (without COF) and catalyzed solution (with COF), respectively. FIG. 12E shows the FT-IR spectra after a single CO₂ absorption test using the uncatalyzed solution (without COF) and catalyzed solution (with 80 ppm COF), and FIG. 12F shows the FT-IR spectra after a single CO₂ absorption-desorption cycle using the uncatalyzed solution (without COF) and catalyzed solution (with 80 ppm COF). The catalyzed solutions (data shown in FIGS. 12B and 12D, and a portion of the data shown in FIGS. 12E and 12F) are example compositions. The uncatalyzed solutions (data shown in FIGS. 12A and 12C, and a portion of the data shown in FIGS. 12E and 12F) are comparative example compositions.

As shown in FIGS. 12A-F, three peaks representing the MEACOO⁻ species: stretching of N—COO⁻ (about 1324 cm⁻¹), symmetric stretching of COO— (about 1488 cm 1), and asymmetric stretching of COO— (about 1561 cm⁻¹) were observed. The peaks at about 1384 cm−¹ and about 1635 cm−¹ were attributed to CO₃²⁻ species and HCO₃ species, respectively.

With the use of the [COOH]₁₇—COF catalyst, the changes in the peak intensities attributed to the HCO₃⁻ species in the CO₂ absorption process (FIG. 12B) increased more quickly than those shown for the catalyst-free solution (FIG. 12A). As shown in FIG. 12E, the peak intensities associated with the MEACOO⁻ species and the Co₃²⁻ species for the catalyzed MEA solutions at the end of CO₂ absorption (about 7200 s) are stronger than those of the uncatalyzed MEA solutions. These results indicate that the use of the [COOH]₁₇—COF catalyst is beneficial for the CO₂ absorption process, especially in the HCO₃ generation process.

Under the conditions tested, Differences are more obvious for the desorption tests as shown in FIG. 12C and FIG. 12D. The peak intensities associated with the MEACOO⁻ species, the CO₃²⁻ species, and the HCO₃ species in the catalyzed spent MEA solutions during CO₂ desorption process (FIG. 12D) decreased faster than those of the uncatalyzed MEA solutions (FIG. 12C), especially the peak intensities attributed to the MEACOO⁻ species and the CO₃²⁻ species. Furthermore, the peak intensities associated with the HCO₃⁻ species, the CO₃²⁻ species, and the MEACOO⁻ species in the catalyzed MEA solutions decreased considerably quick in the initial 10 minutes of the CO₂ desorption.

As shown in FIG. 12F, the peak intensities associated with the HCO₃⁻ species in the catalyzed MEA solutions at the end of CO₂ desorption (30 min) were identical with those in the uncatalyzed solution. The experimental observations of the changes in concentrations of intermediates during the CO₂ desorption process with FT-IR spectra confirm the significant catalytic effect of the [COOH]₁₇—COF catalyst on CO₂ absorption and CO₂ desorption, especially in the MEACOO⁻ and CO₃²⁻ decomposition process.

### C.2. Confirmation of the COF Catalysis Effect by FT-IR Spectroscopy of the Solid Catalyst Portion of the Composition

The FT-IR spectra of the [COOH]₁₇—COF catalyst with CO₂ absorption (used COF) and without CO₂ absorption (fresh COF) are shown in FIGS. 13A and 13B. The FT-IR spectra shown For the data shown in FIGS 13A and 13B, the fresh COF was made using ultrasonic pretreatment as follows: a mixture of about 80 g H₂O and about 80 ppm of [COOH]₁₇—COF catalyst was mixed via ultrasound (power of about 9 W, time of about 30 min) at a temperature of about 30° C. The used COF was made by adding 20 wt % MEA to the ultrasonically pretreated COF, and then run under absorption conditions (inlet gas flow rate of about 500 mL/min; an inlet gas composition of 80 vol % N₂, about 10 vol % CO₂, and about 10 vol % O₂; and an absorption time of about 7200 s) followed by desorption conditions (a carrier gas (N₂) flow rate of about 500 mL/min; a temperature (measured by thermocouple) of about 85° C.; and a desorption time of about 1800 s).

The main characteristic peak positions of used COF remained unchanged from the fresh COF, which indicated that the structure of [COOH]₁₇—COF was unchanged. However, the bands from about 400 to about 445 cm⁻¹ in the used COF (FIG. 13A) are assigned to a C—NH₂ group, which is possibly generated during the CO₂ absorption process. Furthermore, and as illustrated in FIG. 13B, most of the absorption peaks weakened after CO₂ absorption.

FIG. 14 shows exemplary FT-IR spectra of an example catalyst ([COOH]₁₇—COF) in water, with and without ultrasonic pretreatment. The ultrasonic pretreatment was performed by subjecting a mixture of about 80 g H₂O and about 8 mg of [COOH]₁₇—COF catalyst to ultrasound (power of about 9 W, time of about 30 min) at a temperature of about 30° C. The sample without ultrasonic pretreatment is a stirred mixture of about 80 g H₂O and about 8 mg of [COOH]₁₇—COF catalyst.

As shown by the FT-IR spectra of FIG. 14, most of the peaks weakened as a result of ultrasonic treatment, while the peaks at about 641 cm-t, about 1033 cm⁻¹, and about 1280-1350 cm-t strengthened. This result indicated that the ultrasonic pretreatment can weaken most of the bonds except for the aromatic C—H, the aromatic C—N, and the C—O bonds. In addition, the pH of the [COOH]₁₇—COF catalyst aqueous solution decreased from about 6.98 to about 6.77 after ultrasonic pretreatment, indicating that ultrasonic pretreatment can help dissociate the —COOH proton of the [COOH]₁₇—COF catalyst that is used for catalyzing the CO₂ desorption.

Embodiments described herein generally relate to compositions for CO₂ absorption and CO₂ desorption, and to processes for making such compositions. Embodiments described herein also generally relate to processes for CO₂ absorption and for CO₂ desorption using the compositions. The compositions for CO₂ absorption and CO₂ desorption generally include a carbon organic framework (COF) and an organic amine. The COF can accelerate and/or catalyze both absorption and desorption of from the organic amine. Additionally, the COF can be utilized at very low concentrations. Even with the use of low concentrations of catalysts, when the absorption achieves 90% CO₂ capture (the target from the U.S. Department of Energy (DOE) for CO₂ capture efficiency), the amount of CO₂ desorption can be significantly increased relative to conventional technologies.

All documents described herein are incorporated by reference herein, including any priority documents and/or testing procedures to the extent they are not inconsistent with this text.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method, or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “an organic amine” includes aspects comprising one, two, or more organic amines, unless specified to the contrary or the context clearly indicates only one organic amine is included.

Certain molecules disclosed herein may contain one or more ionizable groups [groups from which a proton can be removed (for example, —COOH) or added (for example, amines) or which can be quaternized (for example, amines)]. All possible ionic forms of such molecules and salts thereof are intended to be included individually in the disclosure herein.

While the foregoing is directed to embodiments of the present disclosure, other and further embodiments of the disclosure may be devised without departing from the basic scope thereof, and the scope thereof is determined by the claims that follow.

What is claimed is:

1. A composition for absorbing or desorbing carbon dioxide (CO₂), comprising:
an organic amine; and
a carbon organic framework, an ion thereof, or combinations thereof, the carbon organic framework comprising a plurality of carboxylic acids.

2. The composition of claim 1, further comprising water.

3. The composition of claim 1, wherein the composition comprises greater than 0 wt % and about 1 wt % (about 10,000 ppm) or less of the carbon organic framework based on a total wt % of the composition, the total wt % of the composition not to exceed 100 wt %.

4. The composition of claim 1, wherein the composition comprises greater than 0 wt % about 0.05 wt % (about 500 ppm) or less of the carbon organic framework based on a total wt % of the composition, the total wt % of the composition not to exceed 100 wt %.

5. The composition of claim 1, wherein the composition comprises about 0.005 wt % (about 50 ppm) to about 0.015 wt % (about 150 ppm) of the carbon organic framework based on a total wt % of the composition, the total wt % of the composition not to exceed 100 wt %.

6. The composition of claim 1, wherein the carbon organic framework comprises a compound of formula (I), an ion thereof, or combinations thereof: 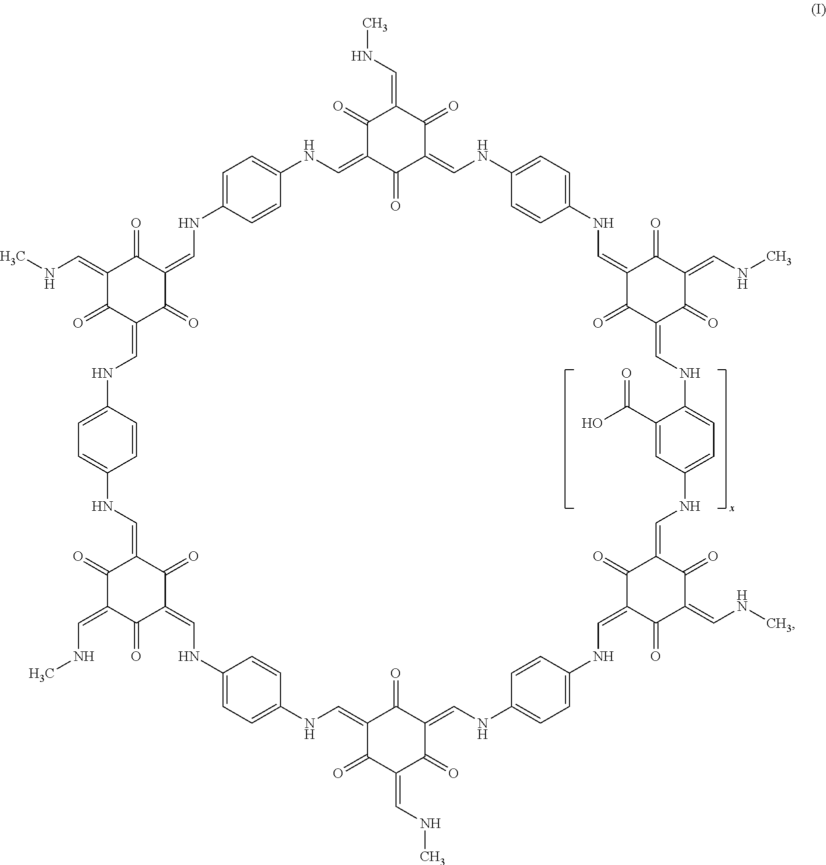
wherein x of formula (I) is from 17 to 100.

7. The composition of claim 6, wherein x of formula (1) is 17, 33, 50, 67, or 100.

8. The composition of claim 1, wherein the organic amine comprises a primary organic amine compound, a secondary organic amine compound, a tertiary organic amine compound, or combinations thereof.

9. The composition of claim 1, wherein the organic amine comprises monoethanolamine, diethanolamine, triethanolamine, diisopropanolamine, monomethyl-ethanolamine, methyldiethanolamine, diethyl-monoethanolamine, or combinations thereof.

10. The composition of claim 1, wherein the organic amine comprises a polyethylene amine, the polyethylene amine comprising diethylenetriamine, triethylenetetramine, tetraethylenepentamine, tetraacetylethylenediamine, pentaethylenehexamine, polyethyleneimine, or combinations thereof.

11. The composition of claim 1, wherein the composition comprises about 10 wt % to about 30 wt % of the organic amine based on a total wt % of the composition, the total wt % of the composition not to exceed 100 wt %.

12. A process for capturing carbon dioxide (CO₂) from a gas stream, comprising:
introducing a gas stream with a composition under absorption conditions, the gas stream comprising CO₂, the composition comprising:
an organic amine, an ion thereof, or combinations thereof; and
a carbon organic framework, the carbon organic framework comprising a plurality of carboxylic acids, ions thereof, or combinations thereof; and
forming a CO₂-enriched composition.

13. The process of claim 12, wherein the carbon organic framework comprises a compound of formula (I), an ion thereof, or combinations thereof: 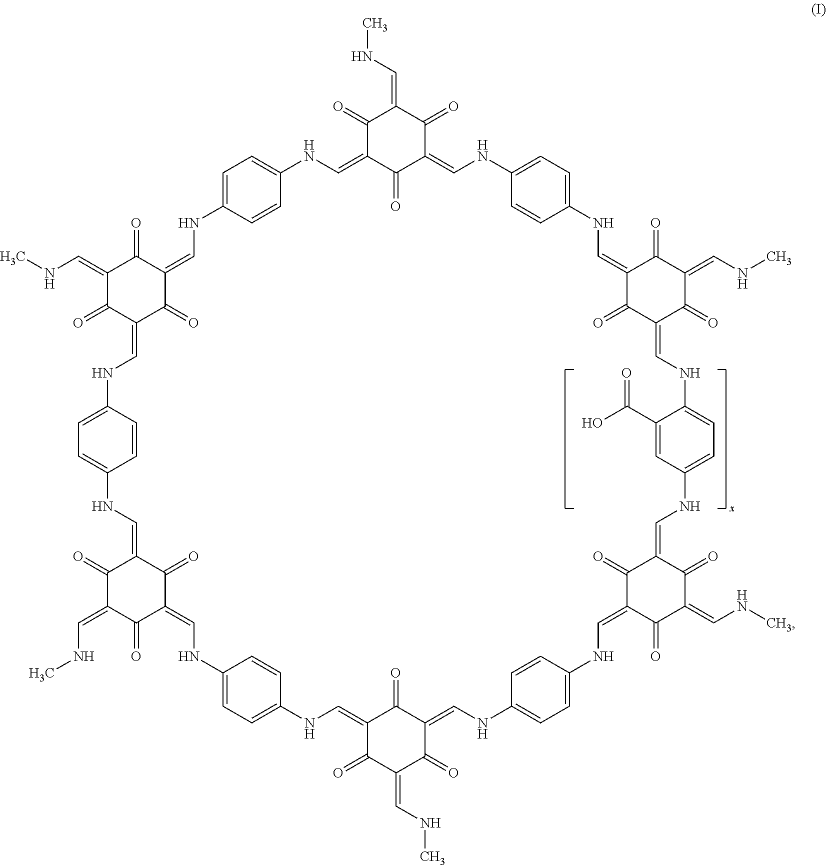
wherein x of formula (I) is 17, 33, 50, 67, or 100.

14. The process of claim 12, wherein the organic amine is selected from the group consisting of monoethanolamine, diethanolamine, triethanolamine, diisopropanolamine, monomethyl-ethanolamine, methyldiethanolamine, diethyl-monoethanolamine, diethylenetriamine, triethylenetetramine, tetraethylenepentamine, tetraacetylethylenediamine, pentaethylenehexamine, polyethyleneimine, or combinations thereof.

15. The process of claim 12, wherein the composition comprises greater than 0 wt % and about 1 wt % (about 10,000 ppm) or less of the carbon organic framework based on a total wt % of the composition, the total wt % of the composition not to exceed 100 wt %.

16. The process of claim 12, wherein the composition comprises about 10 wt % to about 30 wt % of the organic amine based on a total wt % of the composition, the total wt % of the composition not to exceed 100 wt %.

17. The process of claim 12, wherein the composition further comprises water.

18. The process of claim 12, wherein at least a portion of the composition is ultrasonically pretreated.

19. A process for capturing carbon dioxide (CO₂) from a gas stream, comprising:
contacting a gas stream with a composition, under absorption conditions, in an absorption unit to form a CO₂-enriched composition, the gas stream comprising CO₂, the composition comprising:
an organic amine, an ion thereof, or combinations thereof; and
a carbon organic framework, the carbon organic framework comprising a plurality of carboxylic acids, ions thereof, or combinations thereof;
heating at least a portion of the CO₂-enriched composition in the desorption unit;
separating CO₂ from the CO₂-enriched composition to form a CO₂-depleted composition; and
recycling at least a portion of the CO₂-depleted composition to the absorption unit.

20. The process of claim 19, wherein:
heating of the at least a portion of the CO₂-enriched composition is performed at a temperature of about 100° C. or less;
the carbon organic framework comprises a compound of formula (I), an ion thereof, or combinations thereof: 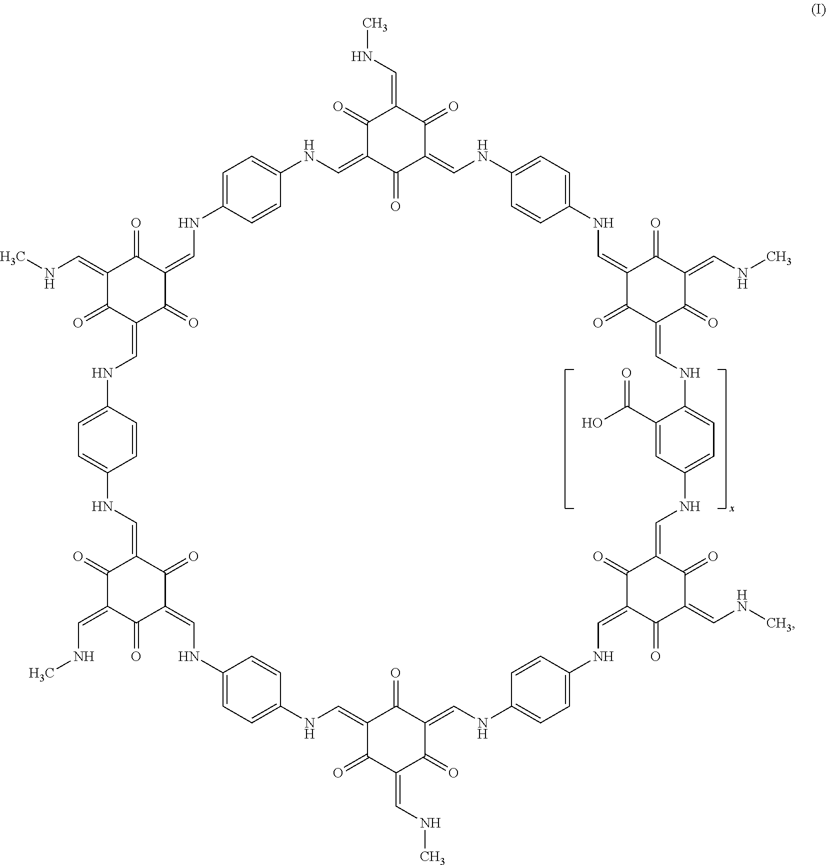
wherein x of formula (I) is 17, 33, 50, 67, or 100; or
combinations thereof.
